(19) United States
(12) Patent Application Publication
(10) Pub. No.: US 2024/0425136 A1
(43) Pub. Date: Dec. 26, 2024

(54) BRAKE PRESSURE SENSOR SYSTEM

(71) Applicant: Jason Carnahan, Meridian, ID (US)

(72) Inventor: Jason Carnahan, Meridian, ID (US)

(21) Appl. No.: 18/677,167

(22) Filed: May 29, 2024

Related U.S. Application Data
(60) Provisional application No. 63/521,905, filed on Jun. 20, 2023.

(51) Int. Cl. B62J 45/41; B62L 1/00; B62L 3/02

(52) U.S. Cl. CPC B62J 45/41; B62L 1/005; B62L 3/023

(57) ABSTRACT

An example brake monitoring system for bicycles comprises at least one force sensing element (FSE) for detecting brake pressure. The FSE may be attached to either a brake lever or a brake pad. A component connects to the FSE and reads force data, and includes a custom PCB, a connector, a battery connector, and resistors for logging and storing brake pressure data in non-volatile storage, or relaying it to a remote system using wireless or wired communication. The system also includes a display device to receive and display brake pressure data. The FSE for brake levers, FSE for brake pads, components, and display devices work together to monitor and display brake pressure data. This system has numerous applications in cycling, including training, safety research, bike design improvement, event organization, bike rental monitoring, and city planning.

### PRIORITY APPLICATIONS

This application claims the benefit of priority to U.S. Provisional Application Ser. No. 63/521,905, filed Jun. 20, 2023, the content of which is incorporated by reference in its entirety.

### BACKGROUND

Bicycle braking analysis tools can be valuable for cyclists who want to improve their braking technique and performance. By providing feedback on braking efficiency, timing, and technique, these tools can help cyclists optimize their braking for safety and performance. Additionally, by tracking braking performance over time, cyclists can identify trends and make adjustments to their equipment or technique as needed.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation illustrating a brake monitoring system including various components such as force sensors and a microcontroller unit, according to some examples.

FIG. 2 is a perspective view illustrating a disc brake assembly with an integrated brake pad sensor, according to some examples.

FIG. 3 is an exploded view illustrating the components of a disc brake assembly including a brake pad sensor, according to some examples.

FIG. 4 is a cross-sectional view illustrating the detailed stack-up of materials and components in a brake pad sensor, according to some examples.

FIG. 5 is a view illustrating a sensor for brake levers, according to some examples.

FIG. 6 is an illustrative view showing the process of embedding a brake lever sensor assembly into a custom foam mold, according to some examples.

FIG. 7 is a perspective view illustrating the completed brake lever sensor assembly encased in custom foam casing and connected with wiring harnesses, according to some examples.

FIG. 8 is a circuit diagram reflecting the construction of a Bluetooth/Microcontroller (MCU) component, according to some examples.

FIG. 9 is a schematic diagram illustrating the MCU component reading and processing data from connected sensors, according to some examples.

FIG. 10 is a perspective view illustrating the MCU component housed within a protective case attached to a bicycle, according to some examples.

FIG. 11 is a schematic diagram detailing the electrical connections and components within a custom Bluetooth MCU component, according to some examples.

FIG. 12 is a user interface diagram illustrating a mobile application interface for setting up and calibrating the brake monitoring system, according to some examples.

FIG. 13 is a user interface diagram illustrating a mobile application interface for recording and displaying real-time brake data during a ride, according to some examples.

FIG. 14 is a schematic diagram illustrating a method of monitoring and transmitting brake pressure data in a bicycle brake monitoring system, according to some examples.

FIG. 15 is a schematic diagram illustrating a method of cycling performance analysis and coaching, integrating brake sensor data with environmental and performance metrics, according to some examples.

FIG. 16 is an illustrative view showing a brake monitoring system for a bicycle, detailing the integration of various components and their interactions, according to some examples.

FIG. 17 is a diagrammatic representation of a machine within which a set of instructions may be executed for causing the machine to perform any one or more of the methodologies discussed herein, according to some examples.

### DETAILED DESCRIPTION

Examples systems and methods operate to detect the brake pressure applied on bicycle brakes, log/store, and/or stream/send brake pressure data in real-time for analysis purposes.

Bicycle braking systems enable cyclists to slow or stop their bicycles. As cycling has become more advanced, tools are needed to analyze braking techniques and performance. These tools, known as bicycle braking analysis tools, provide valuable feedback to cyclists to help improve their braking efficiency, timing, and technique.

Bicycle braking analysis tools may consist of sensors to detect brake pressure, timing, and force, a computing device to collect and process the sensor data, and a user interface to display the results and metrics. The sensors are installed on the bicycle, for example, on the brake levers and brake pads, and detect parameters such as the force applied to the brakes, the duration that force is applied, and the speed of the bicycle during braking. A computing device, such as a smartphone, bike computer, or other portable device, collects the data from the sensors and uses algorithms to calculate metrics related to braking performance. These metrics may include braking power, modulation, brake balance, and braking distance.

Examples discussed herein provide an advanced yet easy-to-use system for monitoring and analyzing bicycle braking performance. Example systems may include streamlined force sensing elements that are simple to install, a computing device to calculate a range of useful metrics related to braking technique, and an interface to provide feedback to the cyclist. The system aims to provide cyclists with a valuable tool for improving their braking skills and safety.

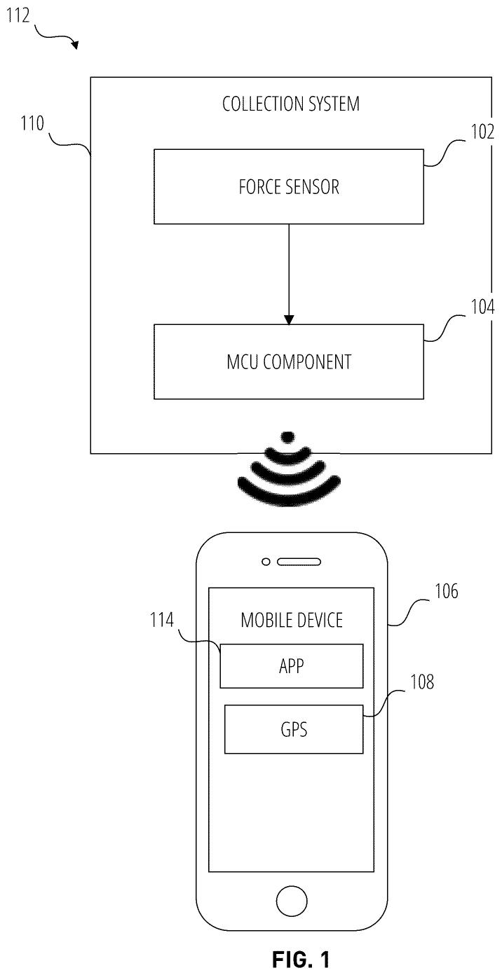

FIG. 1 is a diagrammatic representation of a brake monitoring system 112, according to some examples. The brake monitoring system 112 includes a collection system 110, which includes force sensors 102 and MCU component 104. Operationally, the brake pressure data is read and calculated on a collection system 110 that includes one or more force sensors 102. The brake pressure data is then stored either locally on the collection system 110 or transmitted via a communication protocol such as Bluetooth, Wi-Fi, ANT, Ethernet, USB, etc. The brake pressure data is synchronized with real-time location data (c.g., GPS data) and with regular system timer ticks and stored in non-volatile storage for later analysis.

Examples systems may use one or more of multiple for detecting brake pressure, the method including: 1) sensing the force applied from the brake caliper piston onto the brake pad of a standard manufacturer braking system or 2) sensing the force applied from the operator's finger onto the brake lever.

The collection system 110 includes a Bluetooth Microcontroller (MCU) (e.g., MCU component 104) to collect brake pressure data from the force sensors 102 and sends this data to a storage device, such as a mobile device 106, at a regular interval. The collection system 110 can be easily integrated into an existing bike setup and can provide valuable insights into the effectiveness of a braking system, the braking distance, and the amount of force required to achieve a certain level of braking.

The mobile device 106 may also host one or more applications that make use of the brake pressure data transmitted from the collection system 110 to the mobile device 106. These applications may be third-party applications that have integrations with the brake monitoring system 112 or a dedicated brake data application 114. In some examples, the brake data application 114 may be a cycling coaching application that provides data and coaching to cyclists regarding braking techniques and practice improvements. The brake data application 114 may support a number of use cases and data analytics, as is described in further detail below with respect to use cases.

Examples of the brake monitoring system 112 can be used by cyclists and biking enthusiasts to improve their braking technique and performance. The real-time monitoring and analysis of braking pressure data can help identify areas where braking performance can be improved, such as by applying more force earlier in the braking process. Additionally, the brake monitoring system 112 can provide cyclists with a valuable tool for tracking their braking performance over time and making adjustments to their bike setup or technique as needed.

Considering specific examples, the brake monitoring system 112 may include several components, including:
A brake pad sensor in the example form of a Force Sense Resistor (FSR) for the brake pad (FSR-BP), which is reinforced with Carbon Fiber and Kapton. This FSR-BP is equipped with a small connector and affixed using double-sided tape to the rear side of a brake pad of a bicycle disc brake system. FSR stands for Force-Sensing Resistor, which is a type of sensor that changes its resistance in response to pressure or force applied to its surface. FSRs may consist of a conductive polymer layer sandwiched between two conductive electrodes. When pressure or force is applied to the surface of the sensor, the conductive polymer layer changes its resistance, which can be measured and used to calculate the force or pressure applied to the surface.
A brake lever sensor in the form of an FSR for the brake levers (FSR-BL), which may be embedded in high-strength foam and also fitted with a small connector. The FSR-BL provides an alternative for individuals who prefer not to place a sensor on their brake pads.
Bluetooth component, which is housed in a plastic enclosure and equipped with one or two small connectors for interfacing with the sensors (e.g., the FSRs).
Mobile phone application (e.g., The brake data application 114), developed using the Flutter framework and compatible with both Android and iOS operating systems. The brake data application 114 connects to the Bluetooth MCU component 104 to collect brake data in real-time or near real-time. For example, the brake data application 114 may be a mobile phone application or a bike computer application that displays and logs the brake data for later analysis.

The brake monitoring system 112 may include multiple FSRs to measure brake pressure on both the front and rear brakes of a bicycle. For brake lever FSRs (e.g., the brake lever sensor (FSR-BL) s 502), two FSRs may be used, one for the left brake lever and one for the right brake lever, to measure the brake pressure applied by each hand. The FSRs may be designed to slide over the brake levers and have two output leads (e.g., using a 2-pin connector) that allow the resistance to be measured.

For brake pad sensor FSRs (e.g., the brake pad sensor (FSR-BP) s 204), two FSRs may be used, one for the front brake handle and one for the rear brake handle, to measure the brake pressure applied by each handle. The FSRs may be designed to be attached to the back of the brake pad of a disc braking system. The FSRs may have two output leads (c.g., using a 2-pin connector) that allow the resistance to be measured. The FSRs operate by sensing pressure from the brake piston onto the brake pad and changing the output resistance on the output leads.

When two FSRs are used for front and rear brake pressure measurement, cach FSR is connected to the Bluetooth/MCU component 104 separately. The MCU component 104 reads the pressure data from both sensors at regular intervals and logs/stores the data in non-volatile storage or relays/sends the data to a remote system for analysis.

To differentiate between front and rear brake pressure data, the Bluetooth/MCU component 104 may be programmed to include a channel identifier for each of the front brake and rear brake FSRs. Each FSR is communicatively connected to the MCU component 104 through separate input connectors, and the pressure data is tagged with a respective channel identifier for each FSR to allow for differentiation between front and rear brake pressure measurements.

Alternatively, the Bluetooth/MCU component 104 may be designed to receive a combined signal from both FSRs, which is then processed by the MCU component 104 to differentiate between front and rear brake pressure. This may involve using a multiplexer to switch between the two FSR signals or using signal processing algorithms to extract and differentiate the pressure data from each FSR.

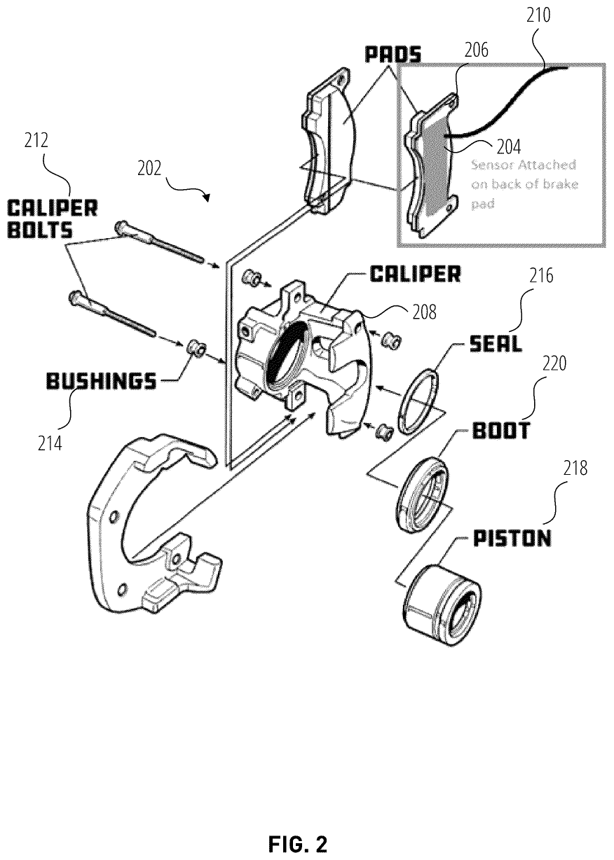

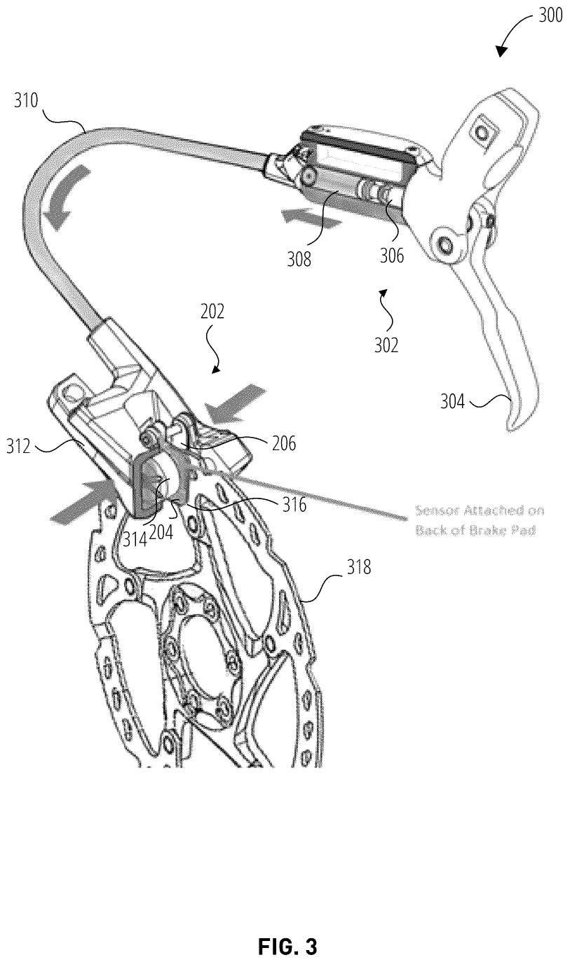

FIG. 2 and FIG. 3 provide perspective views of a disc brake assembly 202 showing a brake pad sensor (FSR-BP) 204 attached on the rear side of a brake pad 206 of the disc brake assembly 202, according to some examples.

FIG. 2 is an exploded view of a caliper disc brake assembly 202 with an integrated brake pad sensor (FSR-BP) 204, detailing the individual components and their assembly relationships.

The disc brake assembly 202 forms the main body of the brake caliper, designed to fit over the brake rotor and house the other components. The brake pads 206, which are friction elements that engage with the brake rotor to provide braking force, are shown separately for clarity. Each brake pad 206 is equipped with a brake pad sensor (FSR-BP) 204 attached to its back. Further details of a brake pad sensor (FSR-BP) 204, according to some examples, are provided below.

The caliper bolts 212 secure the caliper assembly to a braking system, ensuring the caliper remains firmly in place during operation. Bushings 214 are included to provide smooth movement and reduce friction between the caliper assembly and the caliper bolts 212.

To maintain the integrity of the hydraulic system, a seal 216 is positioned around a piston 218, preventing hydraulic fluid from leaking out of the caliper assembly. A boot 220 protects the piston 218 and seal 216 from dust, dirt, and other contaminants that could compromise the brake system's performance. The piston 218 presses the brake pads 206 against the brake rotor when hydraulic pressure is applied, generating the necessary friction for braking

The brake pad sensor (FSR-BP) 204 may be a thin force sense resistor (FSR) sensor that is inserted between the brake pad 206 and the brake caliper piston (not shown) to detect brake pressure. The brake pad sensor (FSR-BP) 204 does not interfere with or modify the operation of the standard system brakes, which continue to operate and are assembled as originally designed. The brake pad sensor (FSR-BP) 204 is thin enough to be inserted between the brake pad 206 and brake caliper 208.

The brake pad sensor (FSR-BP) 204 is designed to be attached to the back of the brake pad 206 of a disc brake assembly 202. It has two output leads 210 (e.g., using a 2-pin connector) that allow the resistance to be measured. The brake pad sensor (FSR-BP) 204 operates by sensing pressure from the brake piston onto the brake pad 206 and changing the output resistance on the output leads.

The brake pad sensor (FSR-BP) 204 is constructed using:
a custom PCB for contacts and rigidity,
a ¾″ hole punch of 0.2 mm thick carbon fiber sheet (creating a carbon disc),
0.1 mm thick double-sided tape (adhered to the carbon disc),.
an Interlink Electronics 34-00126 (FSR UX 402-T, FPC, Bare Tail) with its non-adhesive side adhered to the carbon disc adhesive and soldered to the custom PCB, and. a JST-GH connector soldered to the custom PCB.

The overall thickness of the assembly is approximately 0.75 mm.

The consumer connects the brake pad sensor (FSR-BP) 204 to one of their brake pads 206 using the pre-applied adhesive tape. The consumer then connects the output leads 210 of the brake pad sensor (FSR-BP) 204 to the Bluetooth MCU component 104 using a provided connection wire.

In some examples, the pressure of the brake piston onto the brake pad sensor (FSR-BP) 204 attached to a brake pad 206 may cause damage to the brake pad sensor (FSR-BP) 204. A carbon disc may be inserted between the brake piston and the brake pad sensor (FSR-BP) 204 to prevent this damage.

Further, intense braking may generate excessive force on the brake pad sensor (FSR-BP) 204, which can cause damage to the brake pad sensor (FSR-BP) 204. To prevent this damage, a disc, such as a carbon fiber disc, may be inserted between the brake pad sensor (FSR-BP) 204 and the brake caliper piston (not shown). The disc disperses and absorbs the braking force from the caliper piston, protecting the brake pad sensor (FSR-BP) 204 from damage.

The disc may be constructed of carbon fiber, fiberglass, ceramic, or other high-strength, heat-resistant materials. The disc may have a thickness between 0.5 to 3 millimeters, which provides sufficient strength to withstand braking forces while allowing the brake pad sensor (FSR-BP) 204 to detect changes in pressure. The disc may have a diameter slightly less than that of the brake pad 206, allowing it to be inserted between the brake pad 206 and the caliper piston without interfering with the operation of the brake.

The disc may be secured in place using a high-temperature adhesive or double-sided tape on either side of the disc. The adhesive bonds the disc to the back of the brake pad 206 and the face of the caliper piston, holding it firmly in place during braking. The disc may also have one or more holes or slits cut in its surface to allow for ventilation and heat dissipation. The disc may be designed to withstand temperatures up to 500° C. without significant degradation.

The installation of the disc requires no modification to the existing brake system. The disc can be inserted between the brake pad 206 and the caliper piston and secured in place without altering the brake pad 206, the brake caliper 208, or other brake components. The disc provides an inexpensive, minimally invasive solution for protecting the brake pad sensor (FSR-BP) 204 from damage due to excessive braking forces. The disc, in combination with the Kapton covering, helps ensure the brake pad sensor (FSR-BP) 204 can withstand the high pressures, forces, and temperatures experienced during intense braking.

The ¾″ size for the brake pad sensor (FSR-BP) 204 (and thus the carbon disc) was chosen in order to take advantage of a standard-size force sensor and, therefore, achieve a more favorable cost. The JST-GH connector family was utilized for its low cost, small size, and locking ability.

FIG. 3 depicts a hydraulic disc brake system 300 with an integrated brake pad sensor (FSR-BP) 204, according to some examples. The hydraulic disc brake system 300 comprises several components, each identified with a reference numeral.

The brake lever assembly 302 is located at the top right of the illustration. This brake lever assembly 302 includes a brake lever 304, a master cylinder 306, and a hydraulic fluid reservoir 308. When the brake lever 304 is pressed, it actuates the master cylinder 306, generating hydraulic pressure.

This hydraulic pressure is transmitted through a hydraulic line 310, which connects the brake lever assembly 302 to a brake caliper 208 of the disc brake assembly 202. The brake caliper 208 houses pistons 314 and brake pads 206. The brake caliper 312 is mounted on a brake disc rotor 318, a circular component with perforations designed for heat dissipation.

The brake pads 206 are the friction elements that engage with the rotor 318 to slow down a wheel. One of the brake pads 206 is equipped with a brake pad sensor (FSR-BP) 204 dewcribed herein

Arrows in the illustration indicate the path of hydraulic fluid when the brake lever 304 is actuated, as well as the direction of movement of the caliper pistons 314, which push the brake pad 206 towards the rotor 318. Va

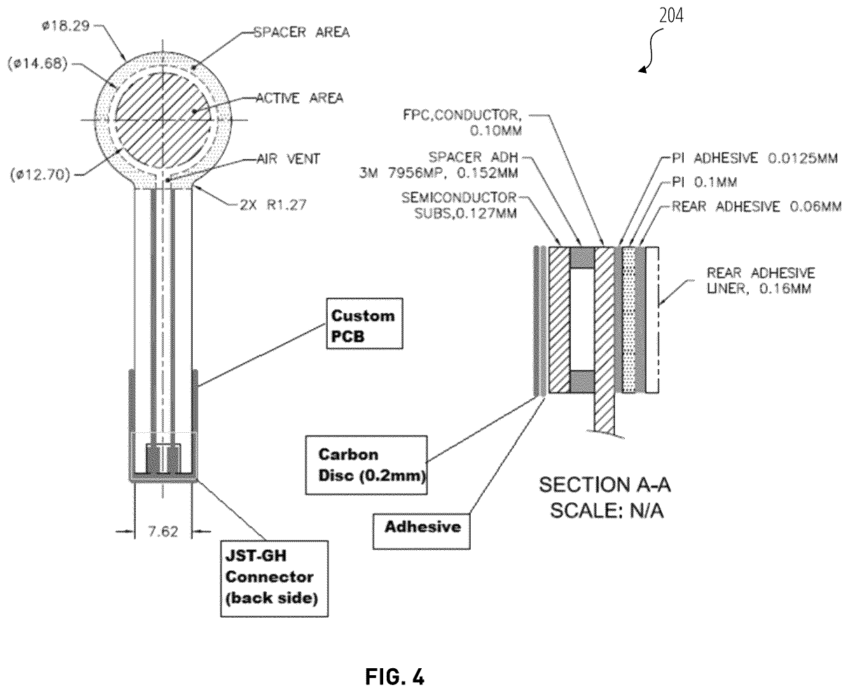

FIG. 4 illustrates the cross-sectional view of the brake pad sensor (FSR-BP) 204, showcasing the detailed stack-up of various materials and components, according to some examples.

The top layer of the sensor features a PI adhesive with a thickness of 0.0125 mm, which securely bonds the polyimide (PI) layer beneath it. This PI layer, with a thickness of 0.1 mm, is known for thermal stability and flexibility, making it suitable for use in the brake pad sensor (FSR-BP) 204.

Beneath the polyimide layer lies the flexible printed circuit (FPC) conductor, measuring 0.10 mm in thickness. This conductor provides the necessary electrical pathways for the sensor's operation.

To ensure consistent spacing between the conductive layers, a spacer made of 3M 7965MP adhesive with a thickness of 0.152 mm is included. This spacer maintains a proper gap that enables accurate pressure detection.

The semiconductor substrate, with a thickness of 0.127 mm, forms the base layer of the sensor. This substrate provides the required electronic properties for the sensor's functionality.

Integral to the sensor's capabilities is a carbon disc, which has a thickness of 0.2 mm. The carbon disc's conductive properties allow it to effectively sense changes in pressure applied to a brake pad.

At the rear of the sensor, there are two adhesive layers. One has a thickness of 0.06 mm and the other 0.16 mm. These layers ensure that the entire sensor stack remains securely bonded, providing durability under the operational conditions of a brake system.

A custom printed circuit board (PCB) is integrated into the sensor, providing the necessary circuitry for processing signals and transmitting data. This PCB is connected to external systems via a JST-GH connector located on the back side of the sensor, enabling data transmission for monitoring and analysis.

The illustration also highlights the active and spacer areas of the sensor. The spacer area, with a diameter of 18.29 mm, surrounds the active area, which has a diameter of 14.68 mm. The active area is where pressure is primarily detected.

To ensure proper ventilation within the sensor assembly and prevent pressure buildup that could affect performance, an air vent with a radius of 1.27 mm is included. This air vent is duplicated for redundancy, ensuring reliable operation.

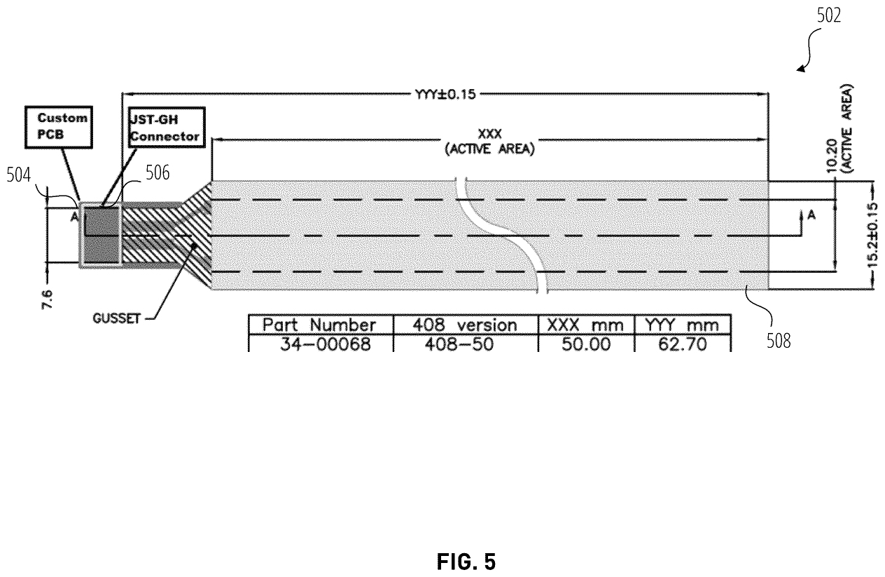

FIG. 5 is a view of a sensor for brake levers (brake lever sensor (FSR-BL) 502), according to some examples. The brake lever sensor (FSR-BL) 502 is designed to detect brake pressure from the operator's finger onto the brake lever. This thin sensor is designed to slide over the brake levers, providing a comfortable and secure grip for the operator while accurately measuring the brake pressure.

The assembly for the brake lever sensor (FSR-BL) 502 comprises:
a custom printed circuit board (PCB 504) for contacts and rigidity,.
an FSR 508, in the example form of an Interlink Electronics 34-00153 (FSR UX 408 50 mm length) with no adhesive (or adhesive covered with tape) soldered to the custom PCB 504, and.
a JST-GH connector 506 soldered to the custom PCB 504.

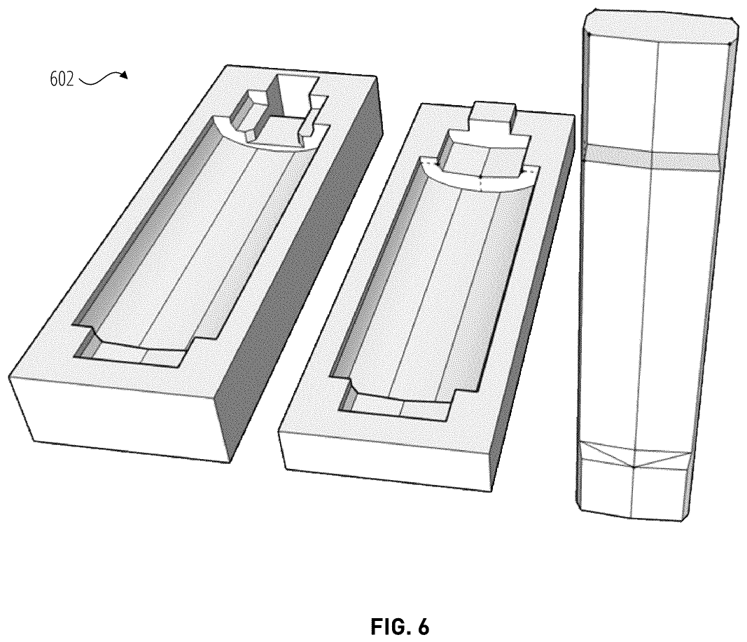

The assembly is then placed into a custom foam mold 602 (see FIG. 6), and Smooth-on FlexFoam-IT 15 (optionally with color) is poured into the foam mold 602. The foam mold 602 is then closed and allowed to cure before the foam assembly is removed from the foam mold 602 and trimmed.

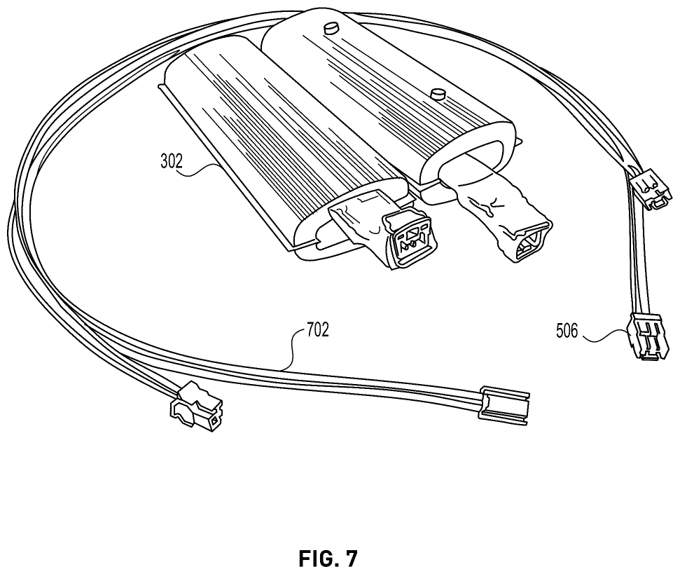

The brake lever sensor (FSR-BL) 502 operates by sensing pressure from the operator's finger onto a brake lever, which changes the output resistance on two output leads 702 (sec FIG. 7). The output leads 702, which utilize the 2-pin connector 506, allow for the resistance to be measured with precision. This design accurately measures brake pressure while maintaining a comfortable and secure grip for the operator.

In terms of construction, the custom PCB 504 utilized in the brake lever sensor (FSR-BL) 502 provides contacts and rigidity for the sensor. The Interlink Electronics 34-00153 (FSR UX 408 50 mm length) with no adhesive (or adhesive covered with tape) is soldered to the custom PCB 504, providing the necessary sensing capabilities. The JST-GH connector 506, soldered to the custom PCB 504, allows for easy connectivity to other components in the brake monitoring system.

The foam mold 602 is custom-designed to fit the brake lever sensor (FSR-BL) 502 assembly and provide a comfortable and secure grip for the operator. Smooth-on FlexFoam-IT 15, a high-quality foam material, is poured into the mold and allowed to cure before the foam assembly is removed and trimmed to the desired shape.

The selection of an Interlink Force Sensor 34-00153 has a size that closely matches that of a bicycle brake lever. This sensor offers high accuracy and reliability, allowing for precise measurement of brake pressure from the operator's finger onto the brake lever. The dimensions of this sensor were a consideration during the design process, as it was necessary to ensure that the sensor would fit securely and comfortably over the brake lever while accurately measuring the brake pressure.

In addition, the choice of encapsulation material was also a consideration in the design of the brake lever sensor (FSR-BL) 502. Flex Foam was selected for the encapsulation material due to its proper adhesion to the force sensor. Other coatings, such as polyurethane or silicone, were found to separate from the force sensor, leading to potential inaccuracies in brake pressure measurement and deterioration of the disc brake assembly 202. Flex Foam provides a durable and reliable encapsulation material that adheres correctly to the FSR 508, ensuring accurate measurements over an extended period.

During the design process, it was also explored whether it could tape and wrap the force sensor assembly directly to the brake lever without encapsulating it in foam. While this solution was found to work sufficiently, it was not considered consumer-friendly, as it did not allow for easy removal of the sensor if it was not desired. As a result, this was not selected but may be offered as a possible solution if desired.

In summary, the selection of the Interlink Force Sensor 34-00153 and the use of Flex Foam encapsulation material were considerations in the design of the brake lever sensor (FSR-BL) 502. These choices ensure accurate measurement of brake pressure from the operator's finger onto the brake lever, while providing a durable and reliable sensor that adheres correctly to the force sensor. The exploration of alternative solutions highlights the commitment to providing a consumer-friendly product that is both accurate and easy to use.

The brake lever sensor (FSR-BL) 502 allows for accurate brake pressure measurement from the brake levers while providing a comfortable and secure grip for the operator. The use of high-quality materials and advanced construction techniques ensures that the brake lever sensor (FSR-BL) 502 is both durable and reliable, providing valuable data for optimizing braking performance in a wide range of cycling applications.

FIG. 6 illustrates the process of embedding the brake lever sensor (FSR-BL) 502 assembly into a custom foam mold 602. This figure details the operations involved in creating a comfortable and secure grip for the operator using a specialized foam material.

The assembly process begins with placing the brake lever sensor (FSR-BL) 502 into the custom-designed foam mold 602. The foam mold 602 is specifically tailored to fit the contours and dimensions of the brake lever sensor assembly, ensuring a precise fit.

Once the sensor assembly is positioned within the mold, Smooth-on FlexFoam-IT 15 is poured into the mold. This foam material is known for its high quality and versatility, providing both comfort and durability. Optionally, color can be added to the foam material to match specific design requirements or preferences.

After the foam material is poured into the mold, the foam mold 602 is closed, allowing the foam to cure. The curing process solidifies the foam, ensuring it takes the shape of the mold and securely encapsulates the brake lever sensor assembly.

Once the foam has fully cured, the foam assembly is removed from the mold 602. The cured foam is then trimmed to the desired shape, ensuring a smooth and ergonomic finish. This trimming process ensures that the final product provides a comfortable and secure grip for the operator, enhancing the usability and effectiveness of the brake lever sensor.

In summary, FIG. 6 provides a detailed view of the process for creating a foam-encased brake lever sensor assembly, highlighting the use of a custom foam mold 602 and Smooth-on FlexFoam-IT 15 to achieve a precise and ergonomic final product.

FIG. 7 illustrates the completed brake lever sensor (FSR-BL) 502 assembly, according to some examples, encased in the custom foam casing and connected with wiring harnesses. This figure demonstrates the final product after the molding and trimming process described in FIG. 6.

The image shows the brake lever sensor assembly fully integrated into the foam casing. The foam casing provides a durable and ergonomic grip for the brake lever, enhancing user comfort and control. The foam material appears to be uniformly applied, indicating a successful molding and curing process.

Two wiring harnesses are attached to the sensor assembly, featuring connectors at each end. These connectors are used to interface the brake lever sensor with external monitoring and control systems. The red and black wires indicate the power and signal lines necessary for the sensor's operation.

The connectors at the end of each wiring harness ensure secure and reliable electrical connections, allowing for accurate data transmission from the brake lever sensor to the vehicle's electronic control unit (ECU) or other monitoring systems.

Overall, FIG. 7 provides a comprehensive view of the brake lever sensor (FSR-BL) 502 assembly in its final form, showcasing the integration of the foam casing and wiring harnesses. This completed assembly is ready for installation and use in a braking system, offering enhanced functionality and user comfort.

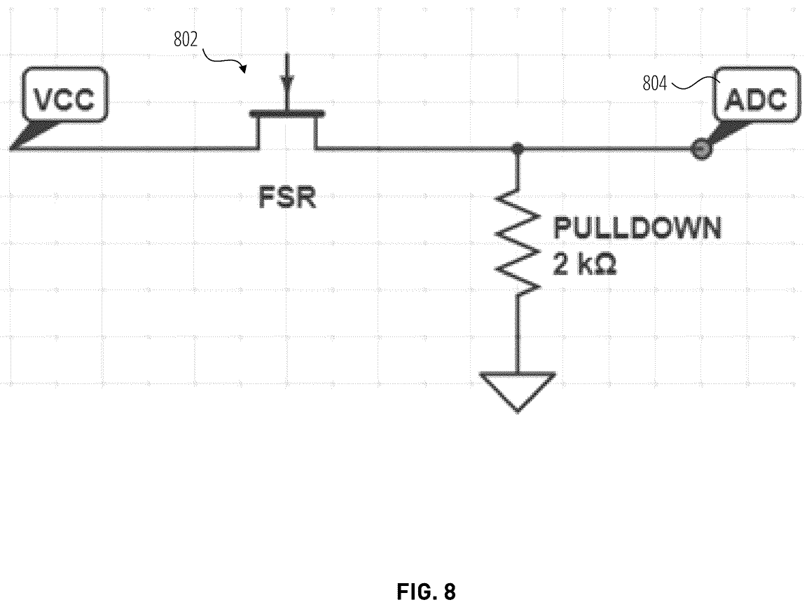

FIG. 8 is a circuit diagram reflecting the construction of a Bluetooth/Microcontroller (MCU) component (c.g., the MCU component 104), according to some examples.

The MCU component 104 connects to the force sensors (e.g., the brake pad sensor (FSR-BP) s 204 and/or the brake lever sensor (FSR-BL) s 502) to read force data. The force sensor inputs are connected to a voltage divider circuit 802, which is then connected to an analog-to-digital converter (ADC 804) peripheral in the MCU component 104. The ADC 804 is read by the MCU component 104 to calculate the amount of pressure applied on the brakes. As brake pressure increases, it causes a Force Sense Resistor to lower its resistance, which in turn causes the voltage on the ADC 804 to increase.

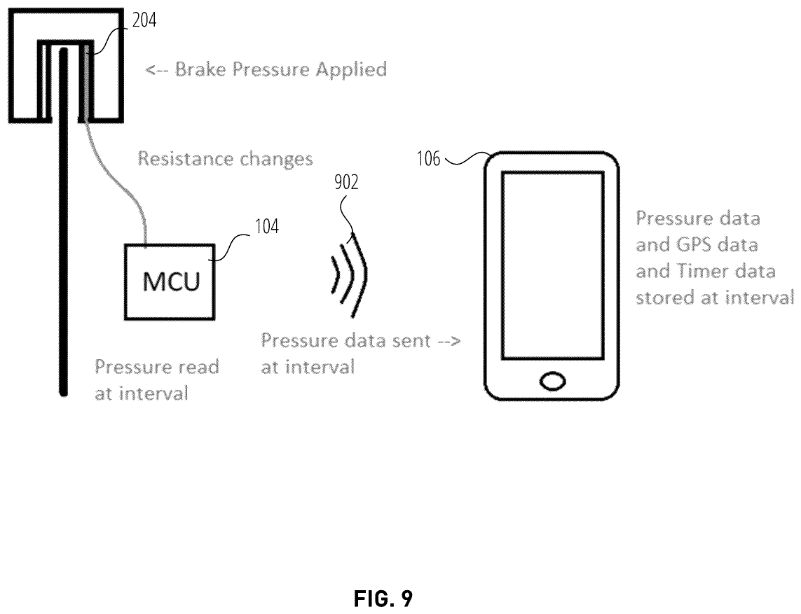

Referring to FIG. 9, the MCU component 104 reading the ADC 804 logs/stores the brake pressure data into non-volatile storage of the MCU component 104 at a regular interval and/or relays/sends brake pressure data to a remote system (e.g., a mobile device 106, such as a phone, bike computer or watch) using a wireless communication channel 902 (e.g., Bluetooth, WiFi, ANT, etc.) or wired (USB, SPI, I2C, Ethernet, etc.).

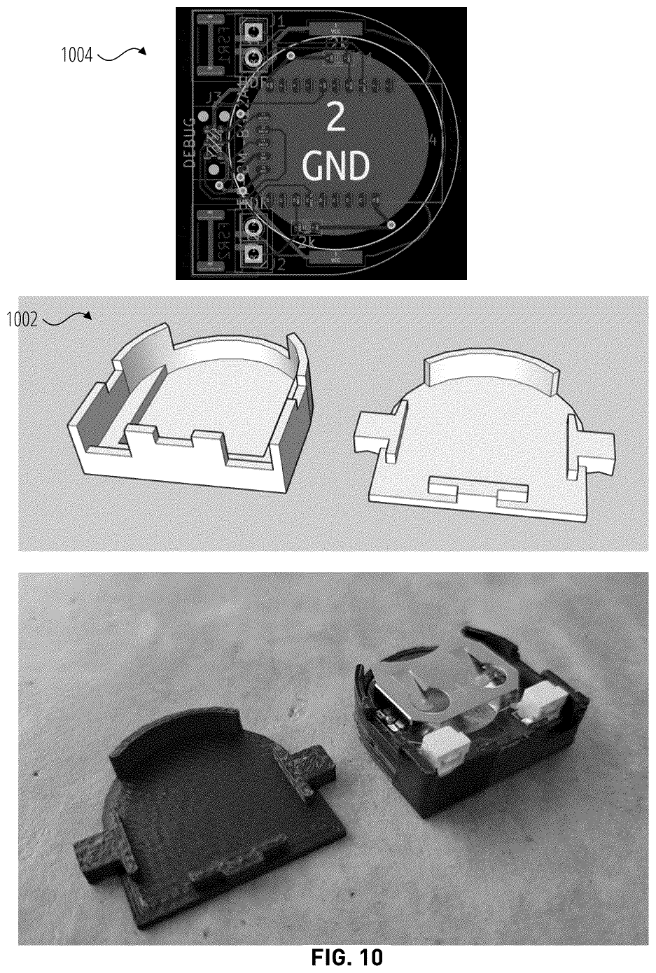

The MCU component 104 is designed with two inputs (e.g., connectors 506) so it can be used with both the single brake pad option and the dual brake lever option. It may be approximately 1 inch in diameter and is powered by a CR2032 battery. This battery may roughly be sufficient for a single biking season. The MCU component 104 fits into a rubber/plastic case 1002 (see FIG. 10) that can be attached to the handlebars or crossbar of the bicycle with a rubber band strap.

The MCU component 104, in some examples, may be constructed as follows:
A custom PCB 1004 for mounting Bluetooth SMT components and connectors;
an RFStar Bluetooth SMT component (EFR32BG22 RF-BM-BG22A1) soldered to the custom PCB 504;
JST-GH connectors soldered to the custom PCB;
a CR2032 Battery connector soldered to the custom PCB; and
2 k Ohm resistors soldered to the custom PCB.

The MCU component 104 is programmed using the Silicon Labs toolset and programming contacts that exist on the custom PCB. The MCU component 104 is placed into the plastic enclosure or case 1002 after it is programmed.

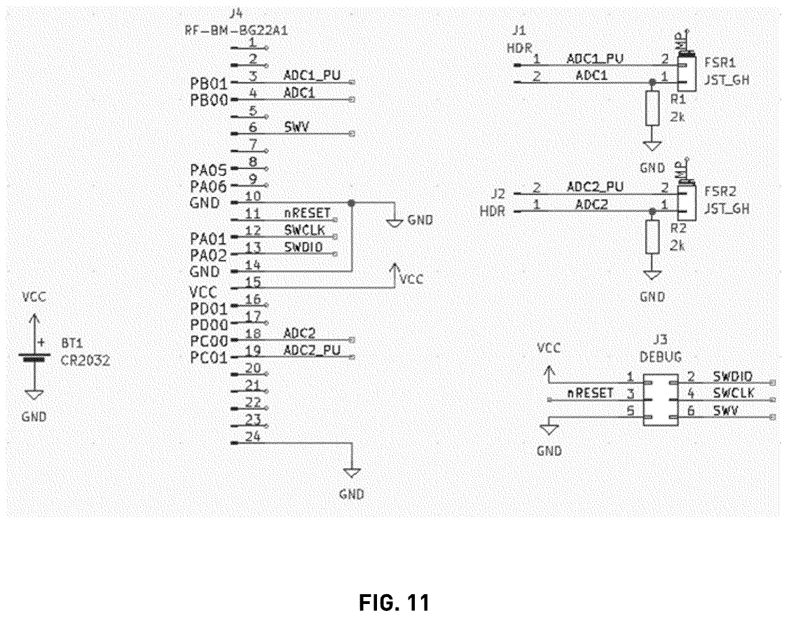

FIG. 11 presents a schematic diagram for the custom Bluetooth MCU (Microcontroller Unit) component 104, detailing the various electrical connections and components necessary for its operation. This figure provides an in-depth view of the circuit design, showcasing the integration of different sensors, connectors, and other elements.

Connectors (J1, J2, J3, J4):
J1 and J2: These are 5-pin JST-GH connectors labeled FSR1 and FSR2, respectively. They are designed to interface with force-sensitive resistors (FSRs). Each connector has a corresponding pull-up resistor (R1 and R2, both 2 k ohms) connected to the ADC1_PU and ADC2_PU lines, facilitating the connection of external sensors to the MCU.
J3: This is a 6-pin connector labeled DEBUG, used for debugging purposes. It provides connections for reset, ground (GND), and supply voltage (VCC), along with other signals necessary for debugging the MCU.
J4: This connector interfaces with an external module, such as an accelerometer or other peripheral, labeled PF-BM-822211. It includes multiple pins for power (VCC, GND), data (PBO0, PBO1, PA06, PA07), and control signals (RESET, SWCLK, SWDIO).

Microcontroller Unit (MCU):
The MCU interfaces with various components and connectors, managing data flow and processing. Key pins on the MCU include:
   PA05, PA06, PA07, PA08: These are general-purpose input/output (GPIO) pins connected to the external module through J4.
   ADC1_PU, ADC2_PU: Analog-to-digital converter (ADC) pins connected to pull-up resistors R1 and R2, which are associated with the FSR sensors connected through J1 and J2.
   PBO0, PBO1: GPIO pins connected to the external module via J4.
   RESET, SWCLK, SWDIO: Pins used for programming and debugging the MCU, connected through J3.

Power and Ground:
The schematic includes multiple connections to VCC (power supply) and GND (ground), ensuring all components receive the necessary power. These connections are distributed throughout the schematic, providing stable power to the MCU and connected peripherals.

Capacitor (C1):
A capacitor labeled 687322 is connected between VCC and GND, providing power supply decoupling. This helps to stabilize the power supply and reduce noise in the circuit.

Pull-up Resistors (R1, R2):
The schematic includes pull-up resistors (2 k ohms each) connected to the ADC1_PU and ADC2_PU lines. These resistors ensure proper voltage levels for the ADC inputs, facilitating accurate sensor readings.

FIG. 11 provides a comprehensive view of the custom Bluetooth MCU component 104, illustrating how various sensors, connectors, and components are integrated into the circuit. This detailed schematic is essential for understanding the electrical connections and functionality of the MCU within the broader syst

### Additional Components

In addition to the components mentioned above, the brake monitoring system 112 may also include further additional components that are discussed below:

Temperature Sensor: A temperature sensor may be integrated into the brake monitoring system 112 to detect the temperature of the brake pads during braking. The temperature sensor can be implemented in various ways, such as using a thermocouple, a thermistor, or an infrared sensor, for example.

When a cyclist applies the brakes, the brake pads generate heat due to friction. The temperature sensor operatively detects this increase in temperature and provides temperature data to the MCU component 104. The temperature data can be used to monitor the temperature of the brake pads during braking and to alert the cyclist if the temperature exceeds a certain threshold.

The implementation of the temperature sensor in the brake monitoring system 112 can be achieved by integrating the sensor into the FSE for brake pads or by adding a separate sensor to the brake monitoring system 112. The sensor can be connected to the MCU component 104 using wired or wireless communication.

In terms of user interfaces, the temperature data can be displayed on the same user interface as the brake pressure data. The user can view the temperature data in real-time, and the collection system 110 may provide alerts if the temperature exceeds a predetermined threshold. The temperature data can also be stored and analyzed over time to provide insights into the performance of the brake monitoring system 112 and to detect any potential issues that may arise due to excessive heat generation.

Brake Light Component: A brake light module may be integrated with or couple to the brake monitoring system 112, and operatively provide visual indication of breaking activity to the rider or other individuals in the vicinity that the cyclist is braking. The brake light component receives brake pressure data from the MCU component 104, which is the central processing unit of the brake monitoring system 112. The brake pressure data may be transmitted by a wire connection or wirelessly from the MCU component 104 to the brake light component.

In order to illuminate a brake light associated with the brake light component, the brake light component may detect when the brake pressure, as indicated by the brake pressure data, exceeds a threshold level. The threshold level may be preset or may be adjustable by the user. When the brake pressure exceeds the threshold level, the brake light component triggers the brake light (e.g., an LED light) to illuminate, indicating that the rider is braking.

A wireless receiving device of the brake light component may be a small device that is attached to the bike frame or other suitable location. Specifically, the regular component is equipped with a wireless receiver and is designed to receive the brake pressure data transmitted from the MCU component 104. Once the data is received, the brake light component processes the data and sends a signal to the LED light to illuminate at a brightness level corresponding to the brake pressure detected.

The LED light used in the brake light component may be a high-intensity LED capable of emitting bright, visible light even in low-light conditions. The LED may be powered by a battery or may be wired directly to a bike's electrical system for power. The brightness of the LED light may be adjustable, allowing the user to customize the light to their desired level of brightness.

The brake light complainant may be designed to be compatible with a variety of bikes and braking systems, allowing it to be easily installed and used by a wide range of cyclists. The breakout component may be weather-resistant and durable, ensuring that it can withstand the rigors of regular use in a variety of conditions.

The brake light module may thus operate to provide safety features that enhances the visibility of the cyclist and helps to prevent accidents. With its wireless capabilities, adjustable threshold level, and high-intensity LED light, the brake light component may offer cyclists an casy-to-use and effective way to improve their safety while riding.

Vibration Component: A vibration component may also be integrated within or communicatively coupled to the brake monitoring system 112, and operatively provides haptic feedback to the rider when the brake pressure exceeds a certain threshold level. This feature is intended to provide an additional layer of feedback to the rider and improve their overall braking performance. The vibration component may be implemented in various ways, such as through the use of a vibration motor or a piezoelectric transducer. In the case of a vibration motor, the motor would be connected to the MCU component 104, which would receive brake pressure data from the FSEs (c.g., FSRs 508, brake pad sensor (FSR-BP) s 204, brake lever sensor (FSR-BL) s 502). When the brake pressure exceeds a certain threshold level, the MCU component activates the vibration motor, causing it to vibrate and provide feedback to the rider.

The vibration component could also be integrated into the mobile phone application, which would provide similar functionality as the brake light component. The mobile phone may use the vibration/haptic functions built into the phone to provide haptic feedback to the rider.

The vibration component may also be configured to provide different levels of vibration feedback based on the level of brake pressure detected by the FSEs. For example, a higher level of vibration feedback could be provided when the brake pressure exceeds a certain threshold level, indicating that the rider may need to adjust their braking technique to avoid a potential lock-up or loss of control. The vibration component may operatively provide riders with real-time feedback on their braking performance and helping to prevent accidents caused by excessive braking force or improper braking technique.

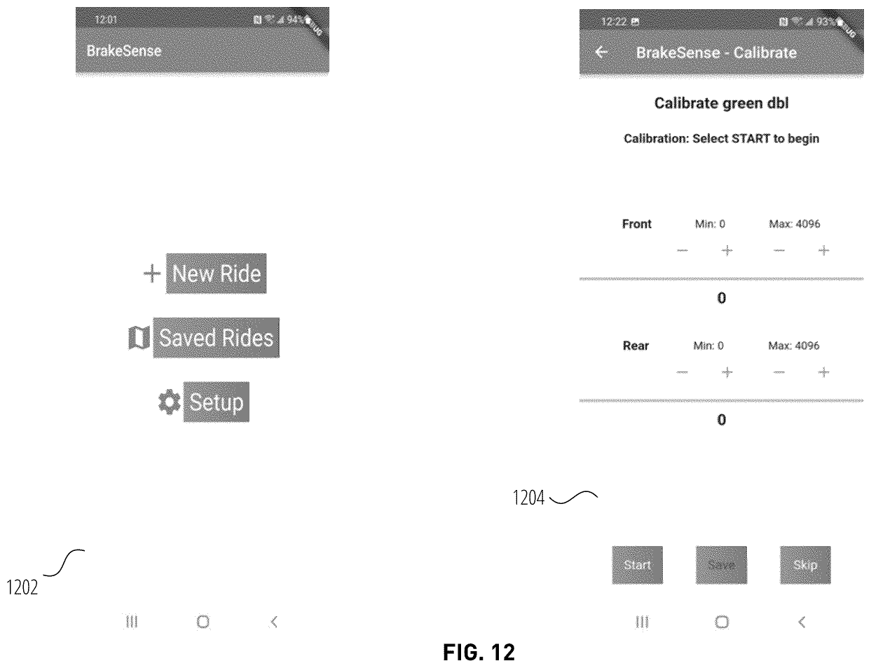

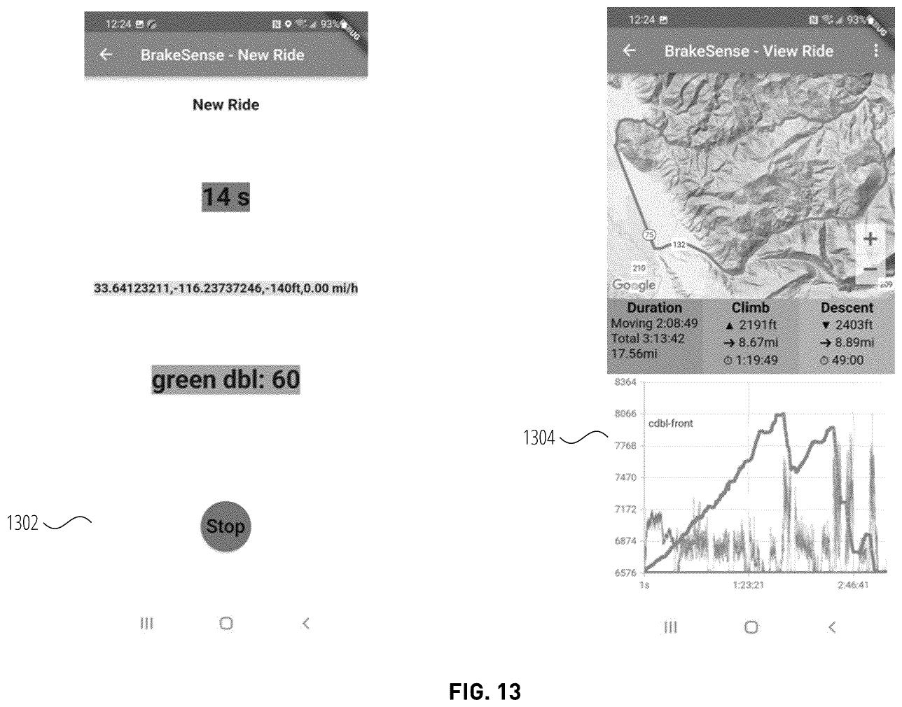

FIG. 12-FIG. 13 are user interface diagrams illustrating a number of user interfaces that may be generated and presented on a mobile device 106 by the brake data application 114, according to some examples.

The brake data application 114 is designed to connect to the MCU component 104 and receive brake data (force sense values) to be used with device setup and brake tracking, for example. The brake data application 114 receives, stores, and displays the brake data. The brake data application 114 handles several functionalities including setup of the MCU component 104 (e.g., discovery and addition to the brake data application 114, naming, calibration), brake data tracking (e.g., reading and storing brake data during a ride), location, elevation, and speed tracking (e.g., reading and storing GPS data during a ride), and brake data display (displaying brake data in connection with GPS data for each recorded ride).

### Data and Metrics

The brake data application 114 supports, in some examples, Bluetooth component (c.g., MCU component 104) discovery and setup, GPS data tracking, background brake data and GPS data collection, ride log file writing, ride log (e.g., brake data, GPS data) display, basic ride metrics (e.g., elevation, speed, front/rear split), and enhanced ride metrics (e.g., feathering, scoring). For example, feathering, also known as modulation, is a braking technique used to provide better control, prevent brake lock-ups and reduce excessive wear on brakes. Feathering involves the application of the brakes in a pulsing manner, as opposed to holding the brake lever continuously. This allows for a more gradual and controlled deceleration, especially in slippery or wet conditions. Feathering can be detected by analyzing the brake data, specifically by reviewing the pattern of brake pressure over time.

On the other hand, brake balance, also known as front/rear split, is a technique used to provide better control (e.g., prevent the rider from flipping over the front handlebars) by activating the rear brake at least as much as, if not more than, the front brake. This technique may better control and stability, especially in emergency stopping situations. The brake data may be used to determine whether the rider was utilizing the front brake more than the rear brake during a period of braking action, which can lead to an imbalance and potentially hazardous situation.

More specifically, the brake data application 114 (with pr without server support) may analyze the brake pressure data to generate useful metrics related to braking performance and technique. These metrics may include:
Feathering: The system can detect feathering, or modulation, of the brakes by analyzing rapid changes in brake pressure over time. Feathering the brakes involves quickly and repeatedly applying and releasing brake pressure, allowing for finer control and modulation of speed. The brake data application 114 may calculate a ‘feathering score’ based on the frequency and magnitude of brake pressure changes during a braking event. A higher score indicates more effective feathering technique.
Brake balance: The brake data application 114 can determine if the front or rear brakes were applied more forcefully during braking by comparing the brake pressure data from the front and rear FSEs. The system may generate a ‘brake balance score’ to indicate if the braking was front-biased, rear-biased, or balanced. A balanced braking technique, where front and rear brakes are applied equally, is considered optimal for safety and control.
Braking power: The brake data application 114 can calculate the total braking power applied during a braking event by integrating the brake pressure data over the duration of braking. Braking power is measured in units such as kilowatt-hours (kWh) and indicates the energy dissipated through braking. This metric can be useful for comparing braking performance between cyclists or over time.
Braking distance: By correlating the brake pressure data with speed data from a GPS or speed sensor, the brake data application 114 can estimate the braking distance required to stop the bicycle. Braking distance is a useful metric for gauging reaction times and the effectiveness of the braking technique. A shorter braking distance indicates more efficient braking.

Other supported features may include ride log comparison, enhanced (sub-second) brake data analysis, and third-party application (e.g., Strava) integration.

### Integrations

Integrating the brake data application 114 with third-party applications includes having the brake data application 114 sends the brake pressure data collected by the brake monitoring system 112 to the third-party application, which then incorporates this data into its own analysis and metrics.

The brake data application 114 uses an API (Application Programming Interface) to integrate with third-party mobile or server applications. To send data to third-party mobile applications, the brake data application 114 uses the provided third-party API to insert brake data in real time. The third-party application then stores and displays the brake data along with internal third-party data, such as GPS data. To send data to third-party server applications, the brake data application 114 sends a POST request to the third-party API containing the ride data, including the brake pressure data, GPS data, and other relevant metrics. The POST request is authenticated using OAuth 2.0, which ensures that the brake data application 114 securely accesses the third-party API. The third-party server application stores and displays the brake data along with internal third-party data to provide the ride information in the native third-party application. The brake data may be inserted into third-party servers as a stand-alone data set or synchronized with an existing data set to enhance the information displayed for the existing data set.

The brake data application 114 may also synchronize data sets between the brake data application 114 and the third-party application, enabling the brake data to be combined with the internal third-party data to provide a comprehensive view of the ride. The synchronization may occur in real time or at a later time, depending on the synchronization settings configured for the third-party application. Overall, the integration with third-party applications provides an enhanced experience for users by allowing them to view their brake data alongside other relevant metrics.

The brake data application 114 may also need to parse the data received from a third-party partner to extract relevant metrics and display them in a meaningful way to the user. This involves coding the data format used by the third-party partners and mapping the brake pressure data to the appropriate fields in the third-party's data model.

The brake data application 114 may also be integrated with many types of third-party applications, such as fitness tracking apps, cycling training apps, or bike-sharing platforms. The integration process for each application of course varies depending on the communication protocol used and the data model used by the third-party application.

Note that the brake monitoring system 112 may integrate with various third-party applications, such as:
Fitness tracking apps: The system can share brake data with fitness tracking applications like Strava, MapMyRide and Endomondo. The brake data, including metrics such as braking power, can be synchronized with the cyclist's ride data in the fitness tracking app to provide a comprehensive view of their cycling performance. A fitness app may use the brake data to provide insights into the cyclist's braking habits and suggest areas for improvement.
Cycling training apps: The system can integrate with cycling training platforms like Zwift, TrainerRoad and The Sufferfest. During structured workouts, a training app can collect brake data in real time and provide feedback on braking techniques. The training app may also review brake data after the workout to generate a ‘braking score’ or other metrics to help the cyclist improve their braking skills over time. The brake data can be combined with power, speed, and other data collected by the training app.
Bike sharing platforms: Bike sharing companies can use the brake monitoring system to gather data on the braking performance of their bikes. The system can transmit brake data, including metrics such as average brake pressure and number of brake applications, to the bike-sharing platform. The platform can analyze the data to determine when bikes need brake maintenance or replacement. The data may also be used to identify areas where additional bike infrastructure is needed to improve safety.

The brake monitoring system 112 can share data with third-party applications through various methods, including:
APIs: The system may use third-party APIs to transmit brake data to applications in real-time or after a ride has been completed. Data is transmitted via API calls and authenticated using OAuth 2.0 or similar protocols.
File exports: The system can allow cyclists to export their brake data in file formats such as .CSV, .FIT or .GPX. The cyclist can then manually upload the data file to a third-party application.
Partnership integrations: Through partnerships with third-party platforms, the brake monitoring system may develop customized integrations to seamlessly transmit brake data to the platforms. These integrations are built to match the data models and communication protocols used by each platform.

### User Interfaces

Turning now specifically to the user interfaces of the brake data application 114, the brake data application 114 provides intuitive user interfaces for interacting with the brake monitoring system 112. Upon opening the brake data application 114, the cyclist is presented with a main screen 1202. The main screen 1202 displays options for:

Calibration setup: The cyclist can initiate the calibration process for the brake monitoring system 112. Calibration involves establishing baseline measurements for the force-sensing elements (FSEs) when no pressure is applied. During calibration, the cyclist ensures the bike is stationary and does not apply pressure to the brake levers or pads. The brake data application 114 reads data from the FSEs and sets the baseline values. Calibration must be performed before the first use and periodically thereafter to ensure accurate measurements. A calibration screen 1204 guides the cyclist through the calibration process and confirms when calibration is complete. The calibration screen 1204 displays instructions for calibrating the brake monitoring system 112. The screen shows an image of the bike with the locations of the FSEs highlighted, and provides the following steps:
Ensure the bicycle is stationary on level ground. Do not apply pressure to the brake levers or pads.
Connect the brake data application 114 to the brake monitoring system 112. This can be done by pairing the mobile device to the Bluetooth component or connecting a cable between the device and the system.
Tap ‘Begin Calibration’ to start the process. The brake data application 114 will read data from the FSEs for 10-15 seconds as baseline values are established.
Once calibration is complete, the brake data application 114 will display the message ‘Calibration successful!’. The baseline values are stored in the brake data application 114 and used to calculate brake pressure during rides.
Calibration must be repeated periodically, such as once a month or if the FSEs are moved or replaced. Tap ‘Recalibrate’ to repeat the calibration process.

The calibration screen 1204 provides clear instructions and confirmation to ensure the brake monitoring system 112 is properly calibrated before each use. Accurate calibration is required to generate precise brake pressure measurements and metrics.

Recording a ride: The cyclist can begin recording a new ride, which activates the brake monitoring system 112 to start collecting and transmitting brake pressure data. A ride recording screen 1302 is displayed, showing the brake data in real-time during the ride. The screen 1302 includes graphical displays of brake pressure (measured in units such as PSI or kPa) for the front and rear brakes. The ride recording screen 1302 may also show additional metrics such as brake balance, braking power and braking distance in real-time. The cyclist can view this information during their ride to get immediate feedback on their braking performance. For example, the ride recording screen 1302 may displayed on the mobile device during an active ride. The ride recording screen 1302 may show the following information in real-time:
Front and rear brake pressure (in PSI or kPa): The current pressure applied to the front and rear brake pads is displayed numerically and on a graphical gauge. The gauges fill from 0 to the maximum measured pressure.
Brake balance: The screen shows the percentage of total braking force being applied to the front vs. rear brakes. A balance of 50% front and 50% rear is optimal.
Braking power: The total energy dissipated through braking so far on the ride is displayed in kWh. Braking power is calculated by integrating the brake pressure over time.
Braking distance: An estimate of the braking distance required to bring the bicycle to a complete stop from the current speed is shown. Braking distance is calculated based on brake pressure, speed, bike weight and other factors.
Additional metrics: The screen may also show metrics such as number of brake applications, average brake pressure, and feathering score.

The ride recording screen 1302 provides real-time feedback on braking performance and technique during a ride. The cyclist can view this information to make immediate adjustments to their braking, ensuring maximum efficiency, safety and control

Viewing a ride: After a ride is complete, the cyclist can view a summary of their ride data. The view ride screen 1304 displays information such as total ride time, distance traveled, average speed, maximum brake pressure, and other metrics. The view ride screen 1304 provides graphical visualizations of the cyclist's brake pressure data over the course of the ride, including charts showing brake pressure at specific points in time. The cyclist can scroll through and zoom in on different parts of the ride to analyze their braking technique in detail. The historical data and metrics are useful for tracking progress over multiple rides and improving braking skills. For example, the view ride screen 1304 displays a summary of the ride data after a ride has been completed. The screen shows:
Ride summary: Total ride time, distance, average speed, maximum speed, elevation gain/loss, and other metrics are displayed.
Brake pressure chart: A line chart shows brake pressure for the front and rear brakes over the duration of the ride. The cyclist can scroll through and zoom in on different parts of the chart. Peaks in the chart indicate where heavy braking was applied.
Additional charts: Charts displaying brake balance, braking power, braking distance and other metrics over time may also be shown. These provide an overview of how braking performance changed throughout the ride.
Ride playback: An interactive map shows the route taken during the ride. The cyclist can tap on points along the route to see details such as speed, brake pressure, and metrics at that location and time. This allows for analysis of how braking was applied at specific points of interest on the ride.
Recommendations: The brake data application 114 provides personalized recommendations for improving braking technique based on the ride data. Recommendations may suggest practicing braking at higher speeds, improving feathering skills, or adjusting brake balance, for example.

The view ride screen 1304 gives the cyclist a comprehensive summary of their braking performance during a ride. The data and visualizations on this screen allow for detailed analysis and review to gain valuable insights into braking technique over the duration of a single ride or multiple rides over time.

Additional screens that may be presented by the brake data application 114 include:

Settings screen: The settings screen allows the cyclist to configure the following options:
Units: Choose between PSI, kPa or bar for displaying brake pressure. The selected units are used throughout the brake data application 114.
Data sharing: Enable or disable sharing brake data with integrated third-party applications such as Strava and TrainingPeaks. When enabled, the brake data application 114 will automatically share brake pressure and metrics with the selected applications after each ride.
Alerts: Set alerts to notify the cyclist if brake pressure exceeds a maximum threshold or if brake balance shifts too far forward or rearward during a ride. The alerts can help prevent loss of control or braking ability.
Connect sensors: Pair additional sensors such as heart rate monitors, power meters or speed/cadence sensors. Data from connected sensors is integrated into the ride data and metrics.
Delete data: Option to delete all stored ride data, metrics, and settings. This resets the brake data application 114 to factory default settings.
About: Displays information such as the software version, build number, and data privacy policy for the brake data application 114.

The settings screen gives the cyclist control over how the brake data application 114 functions and shares data. The options provided allow for customization based on personal preferences and riding style.

Help/Support screen: The Help/Support screen includes the following information:
Documentation: Instructions for installing, calibrating and using the brake monitoring system 112. Includes details on hardware components, the brake data application 114 interface, and data sharing options.
Troubleshooting: Solutions to common issues such as problems connecting sensors, inaccurate brake pressure readings, and errors sharing data with third-party apps. Contact information for technical support is also provided.
Data privacy: Summary of how brake pressure and ride data is stored, accessed, and shared. Provides details on data encryption, third-party integrations, and user rights.
FAQ: Answers to frequently asked questions about the brake monitoring system 112 and brake data application 114. Includes questions on compatibility, subscription options, and future updates.
Contact us: Contact form to reach out to support for any unanswered questions or issues. Users can also provide feedback and suggestions for improving the brake monitoring system 112 and brake data application 114.

The Help/Support screen gives cyclists a comprehensive resource for learning how to properly use the brake monitoring system 112, resolving any technical issues, and understanding how their data is handled. Multiple options are provided for contacting support if additional help is needed.

Accounts screen: The Accounts screen allows the cyclist to:
Create an account: Enter email address and password to set up an account. Accounts enable access to additional features such as long-term data storage, customized training plans, and premium support.
Log in: Enter email address and password to access an existing account.
Recover password: Enter email address to receive a password reset link.
Subscription: View details of an active subscription including renewal date and cancel subscription option. Users can subscribe to monthly or annual plans to access premium features.
Achievements: View badges earned for accomplishments such as total miles ridden, maximum brake pressure achieved, and streaks of recorded rides. Achievements are a fun way for cyclists to track their progress over time.

The Accounts screen allows cyclists to create a personalized account, access subscription services, review achievements, and manage account settings. Accounts provide a convenient way for cyclists to access additional features and keep a long-term record of their brake data and riding stats.

The brake data application 114 provides an easy-to-use interface for cyclists to setup, calibrate, record and view data from the brake monitoring system 112. The brake data application 114 displays brake pressure data and metrics in an intuitive format to provide valuable insights into braking performance during and after rides. Please let me know if you would like me to provide any additional details or modifications to this expansion of the user interface description.

### Use Cases

A number of example use cases for the brake monitoring system 112, using the brake data application 114, include:

Brake tracking over ride: The brake data application 114 may be a cyclist who wants to track their braking performance during a ride. The cyclist would first set up the MCU component 104 by discovering and adding it to the app and calibrating it. During the ride, the brake data application 114 tracks brake data as well as location, elevation, and speed using GPS. After the ride is completed, the cyclist may view their ride log on the brake data application 114, which displays their brake data in connection with their GPS data. This allows the cyclist to analyze their braking performance during different parts of their ride.

Coach assistance: A cycling coach may use the brake monitoring system 112 to track the braking performance of their athletes during training sessions. The coach may use the Bluetooth application to collect brake pressure data from the Bluetooth/MCU component and GPS data from the smartphone or GPS-enabled device used by the athlete. The data collected may include:
Time and duration of braking.
Brake pressure readings from the FSR-BL and FSR-BP
Distance traveled during braking
Speed and acceleration data
Altitude and terrain data
Heart rate and cadence data (if available)

The coach may use this data to analyze the braking performance of the athlete and provide feedback and coaching on how to improve their technique. The coach may use the Bluetooth application to display the data in various user interfaces, such as:
Graphs and charts showing brake pressure readings over time and distance
Maps showing the location of braking events and terrain data
Comparison tools to compare the brake performance of multiple athletes or training sessions.
Recommendations and coaching tips for improving braking technique

The coach may also use the data to track the progress of the athlete over time and adjust their training regimen accordingly. By using the brake monitoring system in conjunction with GPS data, the coach can gain valuable insights into the braking habits of their athletes and help them improve their overall cycling performance.

Group ride comparison: A group of cyclists may use the brake data application 114 to compare their braking performance during a group ride. Each cyclist records their ride using the brake data application 114 and then shares their ride logs with the group via the brake data application 114. The group may then compare their brake data and discuss their braking techniques. the brake data application 114 would need to allow multiple users to record their rides and store the corresponding brake pressure data.

The data may include information such as the brake pressure at various points during the ride, the duration of each braking event, and the speed of the bike during each braking event. This data could be stored locally on each user's device and then shared with the group via the brake data application 114.

To facilitate comparison and analysis of the brake data, the application may include features such as a leaderboard that ranks the cyclists based on their braking performance, or a chart that shows the distribution of braking pressure across the group. The application may also provide visual cues to highlight areas where individual cyclists may need to improve their braking technique.

The user interface of the application would likely include features such as ride summaries, detailed graphs, and charts showing braking data, and tools for sharing and comparing ride data with other users in the group. The interface may also provide options for exporting data in various formats, such as CSV or GPX, to enable further analysis and visualization using external tools.

Progress Tracking: A cyclist may use the brake data application 114 to track their progress over time. The cyclist would record each of their rides using the brake data application 114 and then analyze their brake data over time to see if they are improving their braking technique.

In a progress tracking use case, the brake data application 114 collects and tracks brake pressure data from the FSR-BL and/or FSR-BP sensors during each ride. This data may include information such as brake pressure, duration of brake application, and location of brake application. The brake data is stored in the Bluetooth/MCU component 104 and transferred to the brake data application 114 for analysis. The brake data application 114 may display the data in graphs or charts to allow the cyclist to track their progress over time.

The cyclist may use the application to set goals and monitor their progress towards these goals. For example, they may set a goal to reduce the duration of their brake applications during a ride. The brake data application 114 tracks their progress towards this goal and provide feedback on how to improve their braking technique.

The user interface of the brake data application 114 includes a dashboard showing the cyclist's progress over time, including metrics such as average brake pressure, average duration of brake application, and total number of brake applications. The brake data application 114 may also provide notifications or alerts when the cyclist achieves a new personal best or reaches a goal.

Bike rental monitoring: A bike rental company may use the brake data application 114 to monitor the braking performance of their rental bikes. The company may analyze the brake data to determine when maintenance is needed on the bikes' braking systems.

In this use case, the brake data application 114 is used by a bike rental company to monitor the braking performance of their rental bikes. The brake monitoring system 112 is installed on each bike, and the Bluetooth MCU component 104 is configured to log and store the brake pressure data into non-volatile storage.

The bike rental company can then access the brake pressure data through the brake data application 114. The brake data application 114 may display the data in a dashboard format that shows the average brake pressure over time for each bike in the rental fleet. This data can help the company identify which bikes need maintenance on their braking systems, such as replacing brake pads or adjusting the brake calipers.

Additionally, the brake data application 114 may alert the company when a bike has not been used in a certain amount of time or when a bike has been used excessively. This information can help the company manage their rental fleet more efficiently and ensure that all bikes are in safe working order.

The data collected and tracked in this use case may include average brake pressure over time, number of rides per bike, and time between rides. The user interface on which the data is displayed may include a dashboard with graphs and charts showing the data for cach bike in the rental fleet, as well as alerts for maintenance needs or excessive use.

Bike design improvement: A bike manufacturer may use the brake data application 114 to gather data on the braking performance of their bikes. The manufacturer may analyze the brake data to improve the design of their bikes' braking systems.

The bike manufacturer can use the brake data application 114 to gather data on the braking performance of their bikes and analyze it to improve the design of their bikes' braking systems. They can install the brake monitoring system 112 on their bikes during the testing phase to collect data on the braking pressure, which can be used to assess the effectiveness of the braking system. The data collected can include metrics such as brake pressure, time of application, duration of application, and frequency of use.

For instance, a bike manufacturer can analyze the data to identify any inconsistencies in the braking pressure, which may indicate issues with the brake pads, calipers, or levers. They can also use the data to determine the ideal placement of the brake pads and levers to improve braking efficiency.

The brake data application 114 can display this data in a user-friendly interface, such as graphs and charts, allowing the bike manufacturer to easily analyze and interpret the data. The application can also provide recommendations for design improvements based on the analyzed data.

Bike companies can use the brake monitoring system to gather data on how cyclists use their brakes during real-world riding conditions. By analyzing trends in the brake data, manufacturers can make improvements to the braking systems on their bikes to suit common riding styles. They can also determine optimal brake pad compounds and caliper designs based on metrics such as braking power and heat generation.

Event Organization: A cycling event organizer may use the brake data application 114 to track the braking performance of participants during a race or ride. The organizer may analyze the brake data to determine if any changes need to be made to the course for safety reasons.

The brake monitoring system 112 can be integrated with the event's registration process, allowing participants to download and use the brake data application 114 before the event. The application can then be used to monitor and collect data on the braking performance of each participant during the event.

The data collected by the brake data application 114 may include the time and duration of brake application, the amount of force applied to the brakes, and the speed of the bicycle at the time of brake application. This data can be analyzed to determine the braking performance of each participant, and can be used to identify any potential safety concerns or areas of improvement for the course.

The user interface of the brake data application 114 may include a real-time dashboard that displays the braking performance of each participant during the event. This dashboard can show the braking performance data of each participant, allowing event organizers to quickly and easily identify any potential safety concerns or areas of improvement for the course. The application may also provide a detailed report of the braking performance data after the event, which can be used to make improvements for future events

City planning: A city planner may use the brake data application 114 to gather data on the braking behavior of cyclists in their city. The planner may analyze the brake data to determine if any changes need to be made to the city's cycling infrastructure for safety reasons.

In this use case, the brake data application 114 would collect data on the braking behavior of cyclists in a city. This would likely involve a large-scale deployment of the brake monitoring system 112 on bicycles throughout the city, or a representative sample of the city's cyclists.

The data collected may include information on the frequency and intensity of braking, as well as the duration of braking events. The brake data application 114 may also track location data using GPS to correlate braking behavior with specific areas of the city.

The city planner would use the data to analyze the safety of the city's cycling infrastructure, including bike lanes, intersections, and other areas where cyclists may need to brake. The planner may identify areas where cyclists are braking frequently or suddenly, indicating potential safety hazards. This data could inform decisions on where to build or improve cycling infrastructure, such as adding more protected bike lanes or redesigning intersections to make them safer for cyclists.

The user interface for the brake data application 114 includes visualizations and maps to display the data in an easily digestible format. The planner may also use statistical analysis tools to identify patterns and trends in the data, such as areas where braking behavior is more common during certain times of day or weather conditions.

Municipal governments can use the brake monitoring system to optimize cycling infrastructure in smart cities. The system is deployed on a large scale to gather data on braking behavior across a city's network of bike lanes and paths. City planners analyze the data to identify high-risk areas where cyclists are braking suddenly or frequently. These insights guide decisions on where protected bike lanes, redesigned intersections and other safety improvements would have the greatest impact.

Safety Research: A researcher may use the brake data application 114 to gather data on the braking behavior of cyclists for a study. The researcher may analyze the brake data to draw conclusions about cycling behavior and safety.

In this use case, the brake data application 114 can be used by a researcher to collect data on the braking behavior of cyclists. The researcher may use the brake data application to collect data from a large number of cyclists across different locations and cycling conditions.

The data collected may include information on the braking force, braking pressure, and duration of brake application. The data may also include information on the speed of the cyclist, the terrain, and other environmental factors.

The researcher may use the collected data to analyze the braking behavior of cyclists and draw conclusions about cycling behavior and safety. For example, the researcher may identify common patterns in braking behavior that may lead to accidents and injuries.

The analysis of the collected data may involve the use of statistical methods and machine learning algorithms to identify patterns and correlations. The results of the analysis may be presented in research papers, conferences, and other scientific publications.

The user interface of the brake data application may include features such as data visualization tools, filtering options, and export functionality to enable the researcher to easily access and analyze the collected data. The researcher may also use the application to set up experiments and collect data in a controlled environment.

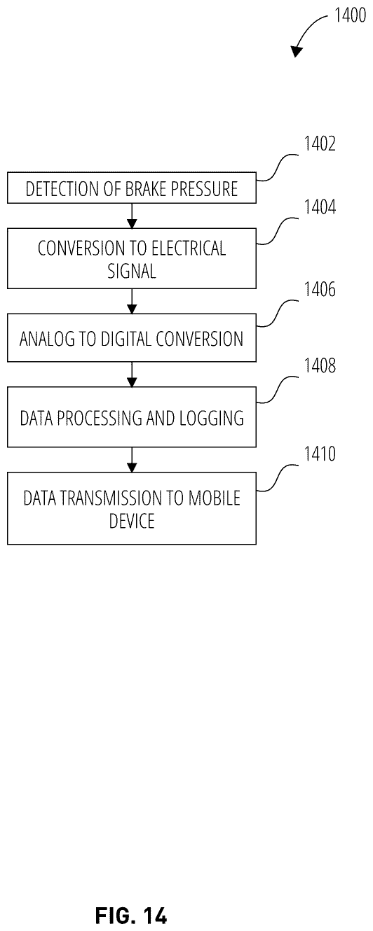

FIG. 14 is a schematic diagram illustrating a method 1400 of monitoring and transmitting brake pressure data in a bicycle brake monitoring system, according to some examples, of implementing real-time data synchronization and analysis.

Although the example method depicted in FIG. 14 illustrates a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 1402, a force sense resistor (FSR) detects brake pressure applied between a brake pad and a caliper piston and/or from the cyclist's finger on the brake lever of a bicycle. The FSR is configured to change its resistance in response to the applied pressure, which is used for determining the braking force exerted by the cyclist.

The FSR operates by utilizing a conductive polymer that changes resistance under pressure. This change in resistance is proportional to the amount of force applied, allowing for precise measurement of the brake pressure, whether it is at the brake pad interacting with the caliper piston or at the brake lever under the cyclist's finger. For brake pad applications, the FSR may be mounted directly on the rear side of the brake pad or integrated into the pad's housing to accurately measure the force exerted by the caliper piston. For brake lever applications, the FSR can be integrated into the lever itself or attached to the surface where the finger applies pressure.

In some examples, the FSR is connected to a voltage divider circuit that includes a fixed resistor. The voltage across the FSR varies with changes in its resistance, which are induced by variations in brake pressure. This voltage is then fed into an analog-to-digital converter (ADC) for digital processing. The design of the FSR and its integration into the brake system is tailored to ensure that it does not interfere with the normal operation of the brake while providing reliable data on brake pressure. This setup allows for continuous monitoring of braking force, which is vital for systems designed to enhance cycling safety and performance through detailed analytics.

At block 1404, the resistance change detected by the FSR is converted into an electrical signal that represents the brake pressure. This conversion is facilitated by a voltage divider circuit connected to the FSR, which adjusts the voltage according to the resistance change.

The voltage divider circuit consists of the FSR in series with a known fixed resistor. As the resistance of the FSR changes in response to varying brake pressure (either from the brake pad or the brake lever), the voltage across the FSR also changes. This voltage change is directly proportional to the pressure exerted, providing a measurable electrical signal that accurately reflects the force applied.

This electrical signal is then ready for further processing. It can be routed to an analog-to-digital converter (ADC) to transform the analog voltage signal into a digital format that can be easily processed by digital systems, such as microcontrollers or computing devices. The precision of the voltage divider and the quality of the ADC play crucial roles in ensuring that the digital representation of the brake pressure is accurate and reliable.

In some examples, the voltage divider may include additional components such as filtering capacitors to stabilize the voltage signal and reduce noise, enhancing the fidelity of the pressure measurement. This setup is critical for systems that rely on precise control and monitoring of braking forces, such as advanced braking assistance systems in bicycles.

At block 1406, an analog-to-digital converter (ADC) receives the voltage from the voltage divider circuit. The ADC converts the analog voltage signal into digital data that quantifies the brake pressure. This digital data is used for precise monitoring and analysis of the braking performance.

The ADC functions by sampling the voltage signal at regular intervals and converting each sample into a digital value that represents the instantaneous voltage level. This process, known as quantization, involves mapping the range of input voltages to a finite number of output digital levels. The resolution of the ADC, expressed in bits, determines how finely the input voltage range is divided and directly impacts the accuracy of the brake pressure measurement.

For instance, a 12-bit ADC can represent the input voltage in 4096 different levels, allowing for a more detailed and precise representation of the brake pressure compared to an ADC with a lower resolution. The digital output from the ADC is then fed into a microcontroller or other processing unit, where it can be used to calculate braking force, monitor system performance, and detect potential issues in the braking system.

In some examples, the ADC may include features such as built-in noise reduction, high sampling rates, and low power consumption, which are beneficial for mobile applications like bicycle brake monitoring systems. These features help to ensure that the brake pressure data is not only accurate but also reliable over time and under various operating conditions. This digital data is crucial for systems that require real-time feedback and advanced data analytics to enhance cycling safety and performance.

At block 1408, a microcontroller unit (MCU) processes the digital data received from the ADC. The MCU logs and stores the brake pressure data at regular intervals, ensuring that detailed records of braking events are maintained. The MCU also synchronizes the brake pressure data with GPS data and system timer data, providing a comprehensive dataset that includes spatial and temporal information about each braking event.

The MCU serves as the central processing unit within the brake monitoring system, handling multiple data streams and executing the embedded software that manages data acquisition, processing, and communication. Upon receiving the digitized brake pressure data from the ADC, the MCU performs several operations. It timestamps cach data point with the current time from its internal clock, which allows for precise tracking of when cach braking event occurs.

Additionally, the MCU integrates the brake pressure data with GPS data, which may include coordinates, speed, and direction of travel. This integration enables the system to correlate braking events with specific locations and movements.

The MCU stores this integrated data in its internal memory or an external storage medium, depending on the system design and requirements. This data logging is used for post-ride analysis and long-term data collection, supporting functionalities such as trend analysis, condition monitoring, and predictive maintenance.

In some examples, the MCU may also implement algorithms to analyze the data in real-time, providing immediate feedback to the cyclist or triggering alerts if abnormal patterns are detected. This could include detecting sudden drops in brake pressure that might indicate a failure in the brake system or providing recommendations for brake maintenance based on accumulated wear and tear data.

Overall, the MCU's ability to process, store, and synchronize multiple data types makes it a pivotal component in advanced bicycle brake monitoring systems, enabling both real-time applications and historical data analysis to enhance cycling safety and performance.

At block 1410, the processed data is transmitted to a mobile device. This transmission may occur over wireless communication protocols such as Bluetooth or Wi-Fi. The mobile device hosts an application that displays the brake pressure data, allowing the cyclist or a technician to analyze the braking performance in real time or after the ride.

The transmission of data from the MCU to the mobile device is facilitated by integrated wireless communication modules within the brake monitoring system. These modules use communication protocols-Bluetooth for short-range transmission and Wi-Fi for longer ranges or when larger amounts of data need to be transferred quickly. The choice of protocol may depend on factors such as the distance between the bicycle and the mobile device, the volume of data being transmitted, and power consumption considerations.

Once the data reaches the mobile device, it is handled by a dedicated application—e.g., brake data application 114. This application presents the data in a user-friendly format, including graphical displays of brake pressure over time, maps showing locations of significant braking events, and statistical analyses of braking efficiency and patterns. The application may also provide tools for deeper analysis, such as comparing current data with historical data to track performance changes or identify potential issues with the braking system.

In some examples, the mobile application can also send commands back to the MCU, allowing for real-time adjustments to data logging parameters or requesting retransmission of data if errors are detected during the initial transmission. This bidirectional communication enhances the system's flexibility and responsiveness, making it more robust and user-friendly.

This setup not only facilitates immediate feedback and on-the-spot diagnostics but also supports more comprehensive post-ride analyses that can help cyclists optimize their performance and maintain their equipment more effectively. The integration of mobile technology with bicycle brake monitoring systems represents a significant advancement in cycling analytics and safety management.

In some examples, the sequence of data processing and transmission may involve alternative configurations. For instance, the data could be processed directly by a computing device integrated within the bicycle, or the data could be transmitted to a remote server for further analysis.

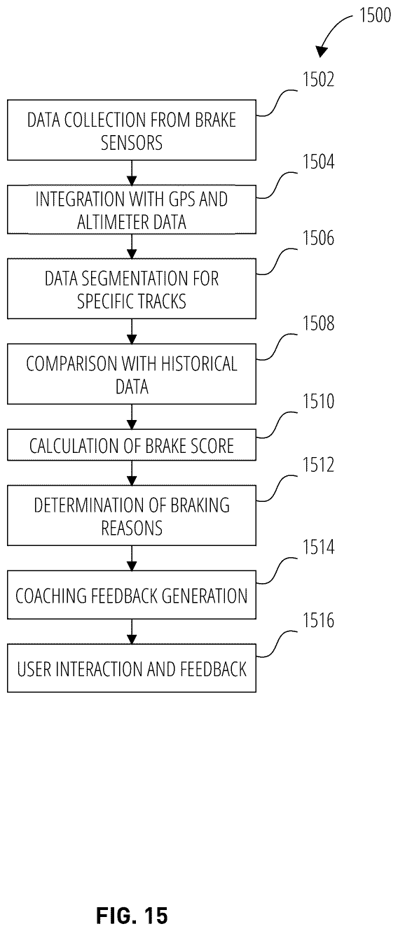

FIG. 15 is a schematic diagram illustrating a method 1500 of cycling performance analysis and coaching, according to some examples, including integrating brake sensor data with environmental and performance metrics. In some examples, the method 1500 may be performed by algorithms with the brake data application 114.

Although the example method depicted in FIG. 15 illustrates a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

At block 1502, brake sensors installed on a bicycle collect data on braking force and duration during a ride. These sensors are capable of providing real-time feedback on the cyclist's braking habits, which is essential for both safety and performance analysis.

In some examples, the brake sensors referred to may include Force Sense Resistors (FSR) such as the FSR-BL for the brake levers and FSR-BP for the brake pads. These sensors detect the amount of force applied by the cyclist on the brake levers and the pressure exerted on the brake pads, respectively. The data collected from these sensors is not only about the magnitude of force but also includes the duration for which the brakes are applied, providing a detailed temporal profile of braking activity during a ride.

The data from these sensors is transmitted to a microcontroller unit (MCU component 104), such as the MCU component 104, which processes this information. The MCU component 104 is programmed to log and analyze this data, converting the raw sensor readings into meaningful metrics that can be understood and utilized by the cyclist or a coaching system.

This processed data might include metrics such as average braking force, total duration of braking throughout the ride, and instances of sudden braking.

At block 1504, the brake data is integrated with GPS and altimeter readings. The GPS component 108 provides location and speed data, while the altimeter measures changes in altitude, essential for assessing the cycling terrain. This integration allows for a comprehensive understanding of the cycling environment and the cyclist's interaction with it.

In some examples, the integration process involves the microcontroller unit (MCU component 104), which receives data streams from both the brake sensors and the GPS/altimeter systems. The GPS component 108 provides precise coordinates and speed information, which are used for mapping the cyclist's route and velocity at any given moment. Concurrently, the altimeter, which may be a barometric altimeter, provides data on elevation changes, offering insights into the terrain's steepness and the potential challenges it poses.

The MCU component 104 uses these data inputs to create a synchronized dataset where each set of brake data is associated with specific GPS coordinates and altitude information. This dataset is structured to allow for a detailed analysis of how braking patterns correlate with changes in terrain and speed. For instance, the system can identify if heavy braking occurs frequently at certain downhill segments or sharp turns, suggesting areas where the cyclist may need to adjust their braking technique or where the terrain poses particular challenges.

Moreover, this integrated data can be used to enhance training programs and cycling performance analysis. By understanding the relationship between location, speed, altitude, and braking, coaches and cyclists can pinpoint specific areas for improvement. For example, they might focus on optimizing braking techniques in downhill sections or improving speed management in varying altitudes.

The data structure used to manage this integrated information typically involves time-stamped records that combine braking intensity, duration, GPS coordinates, and altitude readings. This structured approach not only facilitates immediate feedback and real-time adjustments but also supports long-term data analysis and trend identification, which are invaluable for training and performance evaluations in competitive cycling scenarios.

At block 1506, the combined data is segmented according to specific tracks or loops that the cyclist has ridden. This segmentation is based on GPS coordinates to ensure that comparisons are made between similar segments, providing a reliable basis for performance analysis.

In some examples, the process of segmenting the data involves the microcontroller unit (MCU component 104), which utilizes the GPS data to identify distinct segments or loops that the cyclist has completed during their ride. The GPS coordinates serve as the primary data points for delineating one segment from another, enabling the system to recognize when the cyclist begins and ends a specific loop or track.

The segmentation of data may be used for accurate performance analysis, especially when the cyclist uses the same route for multiple laps or returns to the same track on different days. By segmenting the data according to these GPS-defined tracks, the system can compare performance metrics such as average speed, total braking time, and altitude changes across different attempts or sessions. This allows for a direct comparison of the cyclist's performance on the same route under varying conditions or over time.

Furthermore, this segmented data structure supports more granular analysis, such as identifying specific points within a loop where the cyclist tends to brake more heavily or accelerate. This can help in pinpointing areas that may require more focus in training or adjustments in riding technique.

In some examples, the data segmentation process may also incorporate additional parameters such as time stamps and altimeter readings to enhance the precision of the segment boundaries. For instance, combining time stamps with GPS data can help in distinguishing between pauses and actual completion of segments, ensuring that the data analysis is based on continuous riding periods without interruptions.

At block 1508, the current ride data is compared with historical data from previous rides on the same track. This comparison may involve analyzing speed, braking patterns, and altitude changes to gauge improvement or regression in performance.

In some examples, the microcontroller unit (MCU component 104) or the brake data application 114 performs this comparative analysis. For example, the brake data application 114 accesses a database or storage system where historical data from previous rides is maintained. Each dataset includes detailed records of speed, braking force, braking duration, and altitude changes, tagged with GPS coordinates to ensure they correspond to the same track or loop.

The comparison process starts by aligning the current ride data with the historical data based on the GPS-defined track segments. The brake data application 114 then executes algorithms designed to compare key performance metrics across these datasets. For speed, it may calculate average speeds per segment and compare these averages between the current and past rides. For braking patterns, the analysis may focus on the frequency and intensity of braking, identifying any changes in how the cyclist approaches specific parts of the track, such as sharp turns or steep descents.

Altitude data, combined with speed and braking information, provides insights into how effectively the cyclist manages elevation changes. For instance, if a cyclist shows improved speed on uphill segments without increased braking on the corresponding downhills, it might indicate enhanced fitness and control.

In more specific examples, the brake data application 114 may use statistical methods or machine learning algorithms to quantify improvements or regressions in performance. These methods can detect subtle trends and provide predictive insights, such as forecasting potential performance issues before they manifest significantly.

Moreover, this comparative analysis is not only useful for individual performance tracking but can also be shared with coaches or trainers who use the information to adjust training programs. The ability to track progress over time and against specific benchmarks (like historical performance on the same track) is invaluable for targeted training and achieving competitive advantages.

This structured approach to data comparison ensures that cyclists and their coaches have access to precise, actionable insights derived from a reliable analysis of performance trends over time, tailored to the specific conditions and challenges of the tracks the cyclist frequents.

At block 1510, a brake score is calculated using an algorithm that considers the rate of altitude drop, braking intensity, and speed. This score helps in quantifying the cyclist's braking efficiency and technique, which is particularly useful for coaching purposes.

In some examples, the microcontroller unit (MCU component 104) or the brake data application 114 is responsible for executing the algorithm that calculates the brake score. This algorithm integrates multiple data points collected during the ride, specifically focusing on how the cyclist manages braking in relation to changes in altitude and speed. The rate of altitude drop is measured using data from the altimeter, which provides insights into the steepness of the descent during which the braking occurs. Braking intensity is derived from the force sensors (c.g., FSR-BL and FSR-BP) that measure the pressure applied on the brake levers and pads. Speed data is continuously captured by the GPS component 108.

The brake score algorithm processes these data points to produce a composite score that reflects the cyclist's ability to control their speed and maintain stability over varying terrain. For example, a higher brake score could indicate that the cyclist is effectively using their brakes to manage descents without compromising control or safety, which is critical in downhill cycling scenarios.

In more specific examples, the algorithm may apply weighting factors to different components of the data based on the specific characteristics of the track or the training goals of the cyclist. For instance, on a particularly steep descent, greater emphasis might be placed on how effectively the cyclist manages braking to prevent overspeeding, which could be reflected in the weighting of speed and altitude drop in the brake score calculation.

Furthermore, the calculated brake score can be stored and tracked over time to monitor improvements or declines in the cyclist's braking technique. This historical data can be helpful for coaching, allowing for targeted feedback and personalized training programs that focus on specific areas of improvement identified through the brake score trends.

The brake score provides a quantifiable measure of braking performance that can be used to enhance training outcomes and improve overall cycling safety and efficiency. This metric, derived from a combination of critical ride data, offers a comprehensive assessment of a cyclist's technical skills in managing their bike under various riding conditions.

At block 1512, algorithms analyze the data to determine the reasons for braking, such as approaching corners or steep downhills. This analysis helps in understanding the cyclist's behavior and decision-making during the ride.

In some examples, the microcontroller unit (MCU component 104) or the brake data application 114 use AI algorithms to process the integrated data collected from the GPS, altimeter, and brake sensors. These algorithms are designed to identify patterns and correlations in the data that indicate specific cycling behaviors, particularly focusing on the circumstances under which braking occurs.

The AI algorithms analyze the speed and GPS data to pinpoint locations on a track where braking is initiated. By comparing these locations with the corresponding altitude data and the track's topographical profile, the algorithms can determine if the braking events are associated with environmental features such as sharp turns, steep descents, or potentially hazardous terrain.

In more specific examples, the AI might employ machine learning techniques to improve its accuracy over time. For instance, by feeding back the outcomes of previous analyses, the system can learn to better recognize the characteristics of different track features that may require braking. This learning process allows the AI to provide more precise and context-aware insights into the cyclist's braking behavior.

Furthermore, the AI's analysis extends to evaluating the intensity and duration of braking in relation to the cyclist's speed and the track's features. This detailed analysis helps in assessing whether the braking was reactive (such as in response to an unexpected obstacle) or anticipatory (as a planned response to known track features).

This level of analysis not only enhances understanding of individual braking events but also contributes to broader insights into the cyclist's overall riding strategy and skills. Such insights are useful for coaching, as they allow for targeted advice on how to handle specific parts of a track more effectively, potentially improving both performance and safety.

At block 1514, based on the collected data and its analysis, coaching feedback is generated, for example, by the brake data application 114. This feedback may include tips on feathering, which is the technique of light and controlled braking, and balance between left and right brakes. The feedback is tailored to the cyclist's performance on the specific track and conditions encountered.

In some examples, the brake data application 114 synthesizes the data into actionable coaching advice. The brake data application 114, having access to comprehensive ride data including braking patterns, speed, altitude changes, and GPS tracking, uses this information to assess the cyclist's technique and decision-making during the ride.

The feedback generation process involves analyzing the cyclist's braking efficiency and technique, focusing on how well they manage braking in various situations such as during steep descents, on sharp turns, or in high-speed scenarios. The analysis looks at the consistency and appropriateness of the braking force applied, the timing of the braking, and how well the cyclist maintains control and stability.

In more specific examples, the feedback mechanism may use algorithms that compare the cyclist's current performance against optimal performance models or against the cyclist's past performances. This comparison helps in identifying specific areas where the cyclist can improve. For instance, if the data shows that the cyclist tends to brake too hard on corners, the feedback might suggest techniques for feathering the brakes to achieve smoother deceleration.

Additionally, the feedback can include advice on balancing the use of left and right brakes. Proper balance is needed to maintain control and prevent skidding, especially in wet or slippery conditions. The system can analyze the differential data from sensors on both the left and right brakes to provide personalized recommendations for achieving better symmetry in braking.

This tailored feedback is then communicated to the cyclist, potentially through the brake data application 114 or a bike-mounted display, allowing them to understand and implement the suggestions during their training or recreational rides. This real-time feedback loop not only enhances the learning process but also helps in making immediate improvements, which can be crucial during competitive events or challenging rides.

At block 1516, the cyclist is presented with the generated feedback through a mobile application or a dedicated cycling computer. The cyclist can review their performance, understand the coaching tips, and even provide feedback on the utility of the advice received. This interaction not only helps in improving performance but also enhances the user's engagement with the coaching process.

In some examples, the feedback delivery system involves a mobile device 106 or a cycling computer that is equipped with the necessary software (e.g., the brake data application 114) to interface with the microcontroller unit (MCU component 104). This device displays the feedback in an accessible and user-friendly format, allowing the cyclist to easily comprehend the insights and recommendations based on their recent ride data.

The brake data application 114 or cycling computer displays various aspects of the cyclist's performance, including graphical representations of braking patterns, speed variations, and altitude profiles. It highlights areas where the cyclist performed well and areas needing improvement, based on the analysis conducted in previous blocks. For instance, if the feedback includes tips on feathering, the application might show specific segments of the ride where better feathering could enhance control and safety.

In more specific examples, the feedback system allows for interactive engagement. Cyclists can input their perceptions of the ride and the utility of the feedback received. They might rate the helpfulness of specific tips or comment on areas where the advice was particularly effective or where it fell short. This input is valuable for refining the feedback algorithms and making the coaching process more responsive to individual needs and preferences.

Additionally, the system may include features that allow cyclists to set goals based on the feedback and track their progress over time. This goal-setting feature motivates cyclists to focus on specific aspects of their riding technique and monitor their improvements, further enhancing engagement with the training process.

Overall, the interaction facilitated by the mobile application or cycling computer at this stage is used for closing the feedback loop in the coaching process. It not only provides cyclists with the necessary tools to understand and apply the coaching advice but also involves them actively in their own performance improvement journey, making the entire process more collaborative and tailored to individual needs.

In some examples, alternative data sources such as heart rate monitors or power meters may also be integrated into the analysis to provide even more detailed insights into the cyclist's performance and physiological responses. This comprehensive approach enables a holistic view of cycling performance, tailored coaching, and ultimately, enhanced cycling skills.

The integration of these additional data sources involves the microcontroller unit (MCU component 104), which is configured to receive and process data not only from the standard sensors like GPS, altimeters, and brake sensors but also from heart rate monitors and power meters. Heart rate monitors provide real-time data on the cyclist's physiological state, offering insights into their exertion levels and cardiovascular response during different phases of the ride. Power meters, on the other hand, measure the power output exerted by the cyclist, which is a direct indicator of their performance efficiency and effort.

In more specific examples, the data from heart rate monitors can be analyzed to assess how the cyclist's heart rate correlates with their braking patterns and altitude changes. For instance, an increased heart rate during steep descents might indicate high stress or exertion levels, suggesting areas where the cyclist could benefit from improved braking techniques to maintain control and reduce physical strain.

Similarly, data from power meters can be used to evaluate how effectively a cyclist is translating their effort into forward motion, particularly during braking and acceleration. By analyzing power output in conjunction with braking data, the system can provide targeted advice on how to optimize energy expenditure and maintain a steady performance throughout the ride.

Furthermore, this integrated data approach allows for a more personalized coaching experience. By understanding the cyclist's unique physiological responses and performance metrics, coaches can tailor their feedback more precisely, addressing specific areas such as endurance, strength, or technique that align with the cyclist's individual capabilities and goals.

Overall, the inclusion of heart rate monitors and power meters in the data analysis process enriches the feedback provided to the cyclist. It not only enhances the accuracy of performance assessments but also ensures that the coaching advice is deeply customized to the cyclist's physiological and performance profiles, leading to more effective training outcomes and skill enhancement.

In some examples, alternative data sources such as skin temperature sensors or respiratory rate monitors may also be integrated into the analysis to provide a broader understanding of the cyclist's physiological state during rides. Skin temperature sensors can help in detecting changes in body temperature, which may indicate the onset of fatigue or overheating, particularly during long or strenuous rides. Respiratory rate monitors can provide insights into the cyclist's breathing patterns, which are crucial for assessing their aerobic efficiency and stress levels during intense cycling segments.

In some examples, the integration of cadence sensors, which measure the rate at which a cyclist pedals, can offer additional insights into cycling performance. Cadence data, when analyzed alongside power meter outputs and heart rate data, can help in understanding the cyclist's efficiency in converting pedal strokes into forward motion. This data can be particularly useful in coaching cyclists on optimizing their pedal stroke to maximize power output while minimizing fatigue.

In some examples, wearable technology such as smartwatches or fitness bands could be used as supplementary data sources. These devices often come equipped with accelerometers and gyroscopes that can measure the cyclist's movements and orientation. This data can be useful for analyzing bike handling skills and stability, especially in technical terrains or during aggressive maneuvers such as cornering or descending.

In some examples, environmental sensors could be added to the cyclist's equipment to measure external factors such as wind speed and direction, humidity, and air pressure. These environmental factors can significantly affect cycling performance, and integrating this data can provide valuable context for understanding performance variations under different weather conditions. For instance, higher wind resistance might explain slower speeds or increased power output, which could be crucial for accurate performance analysis and coaching.

In some examples, video analysis technology could be employed to visually capture the cyclist's posture and technique during rides. Video data can be synchronized with sensor data to provide a comprehensive analysis of the cyclist's biomechanics. This approach can be particularly beneficial for identifying and correcting form-related issues that are not easily detectable through sensor data alone, such as body positioning during climbs or sprints.

Overall, the inclusion of these alternative and supplementary data sources can significantly enhance the depth and accuracy of performance analysis, providing cyclists and coaches with a multi-dimensional view of performance that encompasses physiological, mechanical, and environmental aspects. This holistic approach not only aids in fine-tuning training and coaching strategies but also helps in developing a more nuanced understanding of the factors that influence cycling performance.

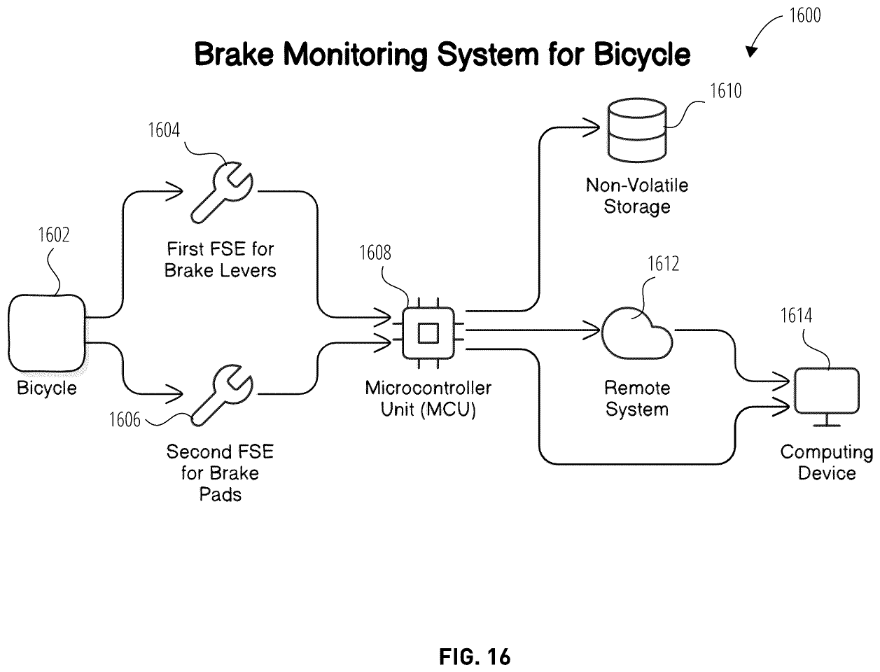

FIG. 16 illustrates a brake monitoring system 112 for a bicycle, detailing the integration of various components and their interactions to ensure effective brake performance monitoring. The system consists of force-sensing elements (FSEs) for both brake levers and brake pads, a microcontroller unit (MCU), non-volatile storage, a remote system, and a computing device, each with specific reference numerals.

The bicycle force sensor 102 is equipped with two distinct types of force-sensing elements. The first force-sensing element 1604 is installed on the brake levers. This sensor detects the force applied by the rider, providing real-time data on braking force and usage frequency.

The second force-sensing element 1606 is positioned on the brake pads. It monitors the pressure applied to the brake pads.

A microcontroller unit, or MCU 1608 receives data from both force-sensing elements, processes this information, and communicates with other system components. It plays a role in aggregating and analyzing sensor data to provide insights into the braking performance, as noted herein.

Non-volatile storage 1610 is used to store data collected by the MCU 1608. This storage ensures that braking data is saved even when the system is powered off, allowing for historical data analysis and trend monitoring.

The MCU 1608 transmits processed data to a remote system 1612, typically through a wireless connection. This remote system may be a cloud-based server that collects data from multiple bicycles, enabling comprehensive analysis and reporting.

Users interact with the system through a computing device 1614, which can be a bike, computer, smartphone, tablet, or computer. This device interfaces with the remote system to provide users with detailed reports, real-time monitoring, and alerts regarding the bicycle's braking system. The computing device allows users to track brake performance, schedule maintenance, and receive notifications about brake pad wear and necessary adjustments.

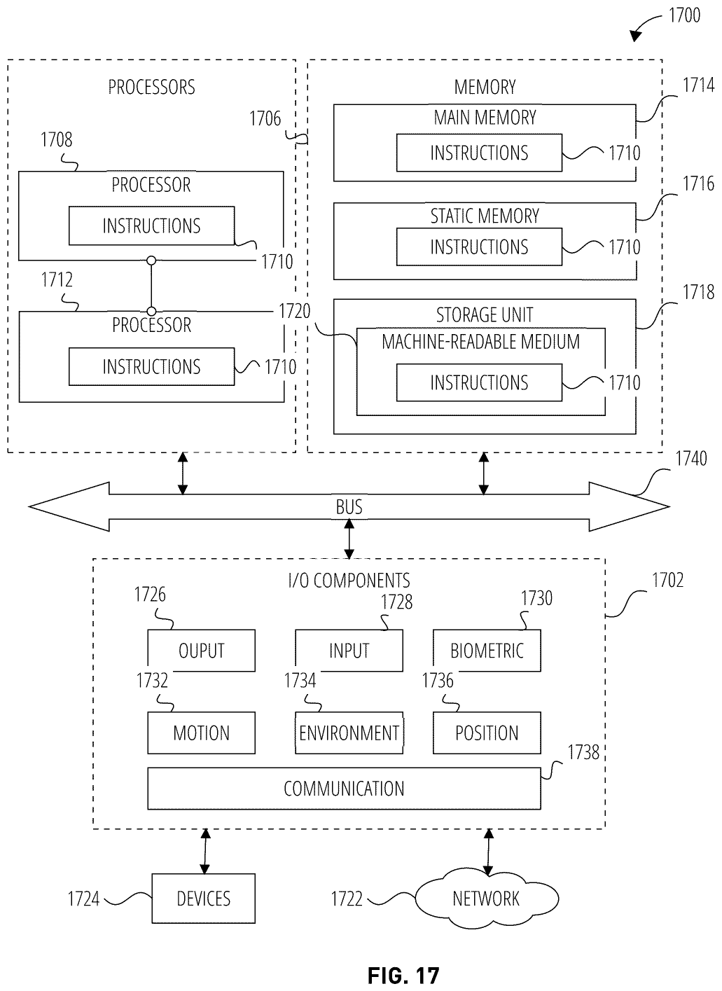

FIG. 17 is a diagrammatic representation of the machine 1700 within which instructions 1710 (e.g., software, a program, an application, an applet, an app, or other executable code) for causing the machine 1700 to perform any one or more of the methodologies discussed herein may be executed. For example, the instructions 1710 may cause the machine 1700 to execute any one or more of the methods described herein. The instructions 1710 transform the general, non-programmed machine 400 into a particular machine 1700 programmed to carry out the described and illustrated functions in the manner described. The machine 1700 may operate as a standalone device or be coupled (e.g., networked) to other machines. In a networked deployment, the machine 1700 may operate in the capacity of a server machine or a client machine in a server-client network environment, or as a peer machine in a peer-to-peer (or distributed) network environment. The machine 1700 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (c.g., a smartwatch), a smart home device (c.g., a smart appliance), other smart devices, a web appliance, a network router, a network switch, a network bridge, or any machine capable of executing the instructions 1710, sequentially or otherwise, that specify actions to be taken by the machine 1700. Further, while a single machine 1700 is illustrated, the term “machine” may include a collection of machines that individually or jointly execute the instructions 1710 to perform any one or more of the methodologies discussed herein.

The machine 1700 may include processors 1704, memory 1706, and I/O components 1702, which may be configured to communicate via a bus 1740. In some examples, the processors 1704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), a Tensor Processing Unit (TPU), a Neural Processing Unit (NPU), a Vision Processing Unit (VPU), a Machine Learning Accelerator (MLA), a Cryptographic Acceleration Processor, a Field-Programmable Gate Array (FPGA), a Quantum Processor, another processor, or any suitable combination thereof) may include, for example, a processor 1708 and a processor 1712 that execute the instructions 1710.

Although FIG. 17 shows multiple processors 1704, the machine 1700 may include a single processor with a single core, a single processor with multiple cores (c.g., a multi-core processor), multiple processors with a single core, multiple processors with multiple cores, or any combination thereof. Modern processor architectures include superscalar, very long instruction word (VLIW), vector processor, multi-core, manycore, neuromorphic, and quantum architectures.

The memory 1706 includes a main memory 1714, a static memory 1716, and a storage unit 1718, both accessible to the processors 1704 via the bus 1740. The main memory 1706, the static memory 1716, and storage unit 1718 store the instructions 1710 embodying any one or more of the methodologies or functions described herein. The instructions 1710 may also reside, wholly or partially, within the main memory 1714, within the static memory 1716, within machine-readable medium 1720 within the storage unit 1718, within the processors 1704 (e.g., within the processor's cache memory), or any suitable combination thereof, during execution thereof by the machine 1700.

The I/O components 1702 may include various components to receive input, provide output, produce output, transmit information, exchange information, or capture measurements. The specific I/O components 1702 included in a particular machine depend on the type of machine. For example, portable machines such as mobile phones may include a touch input device or other such input mechanisms, while a headless server machine will likely not include such a touch input device. The I/O components 1702 may include many other components not shown in FIG. 17. In various examples, the I/O components 1702 may include output components 1726 and input components 1728. The output components 1726 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (c.g., a vibratory motor, resistance mechanisms), or other signal generators. The input components 1728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 1702 may include biometric components 1730, motion components 1732, environmental components 1734, or position components 1736, among a wide array of other components. For example, the biometric components 1730 could include components to detect expressions (e.g., hand gestures, facial expressions, vocal expressions, body movements, or eye tracking) or measure biosignals (e.g., heart rate, blood pressure, body temperature, perspiration, or brain waves) in an aggregate, anonymous way that does not identify individuals. Technologies like facial recognition, fingerprint identification, voice identification, retinal scanning, or electroencephalogram-based identification are of course only be implemented with explicit informed consent from users, if at all. When biometric data is collected, it is minimized, encrypted, and accessed only for authorized purposes. Users are able to opt-out of biometric collection by the biometric components 1730 and have their data permanently deleted. With proper consent, security protections, data minimization, and respect for user privacy, certain biometric components may be implemented ethically.

The motion components 1732 include acceleration sensor components (e.g., accelerometer), gravitation sensor components, rotation sensor components (c.g., gyroscope). The environmental components 1734 include, for example, one or cameras, illumination sensor components (e.g., photometer), temperature sensor components (e.g., one or more thermometers that detect ambient temperature), humidity sensor components, pressure sensor components (c.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1736 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1702 further include communication components 1738, operable to couple the machine 1700 to a network 1722 or devices 1724 via respective coupling or connections. For example, the communication components 1738 may include a network interface Component or another suitable device to interface with the network 1722. In further examples, the communication components 1738 may include wired communication components, wireless communication components, cellular communication components, Near Field Communication (NFC) components, Bluetooth® components (c.g., Bluetooth® Low Energy), Wi-Fi® components, and other communication components to provide communication via other modalities. The devices 1724 may be another machine or any of a wide variety of peripheral devices (e.g., a peripheral device coupled via a USB).

Moreover, the communication components 1738 may detect identifiers or include components operable to detect identifiers. For example, the communication components 1738 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 1738, such as location via Internet Protocol (IP) geolocation, location via Wi-Fi® signal triangulation, or location via detecting an NFC beacon signal that may indicate a particular location.

The various memories (e.g., main memory 1714, static memory 1716, and/or memory of the processors 1704) and/or storage unit 1718 may store one or more sets of instructions and data structures (c.g., software) embodying or used by any one or more of the methodologies or functions described herein. These instructions (e.g., the instructions 1710), when executed by processors 1704, cause various operations to implement the disclosed examples.

The instructions 1710 may be transmitted or received over the network 1722, using a transmission medium, via a network interface device (e.g., a network interface component included in the communication components 1738) and using any one of several well-known transfer protocols (e.g., hypertext transfer protocol (HTTP)). Similarly, the instructions 1710 may be transmitted or received using a transmission medium via a coupling (e.g., a peer-to-peer coupling) to the devices 1724.

### Methods of Manufacture

A method of manufacture for the force sensing element (FSE) for brake levers (FSR-BL) may include, according to some examples:
Design and fabricate a custom printed circuit board (PCB) to provide contacts and rigidity for the FSR-BL. The PCB will have two solder pads to which the force sensing resistor (FSR) will be attached, as well as two output leads with a connector for transmitting the measured resistance. The PCB is designed using CAD software and fabricated from FR4 fiberglass material using standard PCB manufacturing processes.
Obtain an Interlink Electronics FSR model 34-00153, which is a 50 mm long force sensing resistor. This FSR is selected due to its suitable size for measuring force on a bicycle brake lever. The FSR has no adhesive backing, so it will be attached to the PCB using solder.
Solder the FSR onto the two solder pads on the PCB. The FSR is placed so that it will run along the length of the brake lever, allowing it to detect force from the cyclist's fingers pressing on the lever. The soldering is performed using a fine-tip soldering iron and lead-free solder.
Connect a 2-pin JST-GH connector to the output leads on the PCB. This connector allows the FSR-BL to be connected to the microcontroller unit (MCU) for relaying the measured resistance. The JST-GH series is selected for its small size, locking ability, and low cost.
Place the PCB and FSR assembly into a foam mold. The foam mold is custom designed to securely hold the assembly in the proper shape and position for measuring force on a brake lever. Smooth-On FlexFoam-iT 15 is poured into the mold and allowed to cure, encapsulating the assembly.
Once cured, remove the foam mold. Trim away any excess foam material from the assembly using a knife, leaving the FSR-BL with a shape suitable for sliding over a bicycle brake lever.
Calibrate the FSR-BL by connecting it to the MCU, which applies a known force to the FSR-BL and records the measured resistance. The MCU stores the calibration data for use in converting subsequent resistance measurements into force values.
The FSR-BL is now ready to be used to detect brake pressure by sliding it over a bicycle brake lever. When the cyclist applies force to the brake lever, the FSR-BL measures the change in resistance, which the MCU converts into a force value using the calibration data.

A method of manufacture for the force sensing element (FSE) for brake pads (FSR-BP), according to some examples, may include:
Design and fabricate a custom printed circuit board (PCB) to provide contacts and rigidity for the FSR-BP. The PCB will have two solder pads to which the force sensing resistor (FSR) will be attached, as well as two output leads with a connector for transmitting the measured resistance. The PCB is designed using CAD software and fabricated from FR4 fiberglass material using standard PCB manufacturing processes.
Obtain an Interlink Electronics FSR model UX 402-T, which is a 0.2″ diameter round force sensing resistor. This FSR is selected due to its suitable small size for measuring force between a brake pad and caliper piston. The FSR has an adhesive backing, which will be attached to the PCB.
Remove the adhesive backing from the FSR and adhere it to the center of the PCB, covering the two solder pads. The FSR is placed so that it will be positioned between the brake pad and caliper piston, allowing it to detect force from the caliper piston pressing on the brake pad.
Connect a 2-pin JST-GH connector to the output leads on the PCB. This connector allows the FSR-BP to be connected to the microcontroller unit (MCU) for relaying the measured resistance. The JST-GH series is selected for its small size, locking ability, and low cost.
Cut a ¾″ diameter disc from a sheet of 0.2 mm thick carbon fiber. The carbon fiber disc provides protection and rigidity for the FSR. An adhesive backing is applied to one side of the disc.
Remove the adhesive backing from the carbon fiber disc and adhere it to the top of the FSR, covering the FSR and PCB assembly. The disc is centered over the FSR, providing even protection and force distribution.
Apply a Kapton tape covering over the entire top surface of the carbon fiber disc and PCB. The Kapton tape protects the assembly from excessive heat generated during braking. Two small holes are left in the Kapton tape over the solder joints of the output leads to avoid covering the electrical connections.
Calibrate the FSR-BP by connecting it to the MCU, which applies a known force to the FSR-BP through the carbon fiber disc and records the measured resistance. The MCU stores the calibration data for use in converting subsequent resistance measurements into force values.
The FSR-BP is now ready to be installed between a brake pad and caliper piston to detect brake pressure. When the caliper piston applies force to the brake pad, the force is transmitted through the carbon fiber disc to the FSR-BP, which measures the change in resistance. The MCU converts this into a force value using the calibration data.

### Methods of Installation

Method of installation for the force sensing element for brake levers (FSR-BL), according to some examples, may include:
Turn off the bicycle and engage the brake to lock the wheels in place. This prevents the bike from rolling during installation of the FSR-BL.
Locate the brake lever onto which the FSR-BL will be installed. The FSR-BL is designed to slide over and conform to the shape of the brake lever, with the force sensing resistor (FSR) running along the length of the lever.
Holding the brake lever in one hand, slide the FSR-BL over the end of the lever with your other hand. Gently work the FSR-BL onto the lever using small back-and-forth motions until it slides completely over the lever. The FSR-BL should fit snugly but still allow free movement of the lever.
Connect the output leads of the FSR-BL to the input leads on the microcontroller unit (MCU component 104) using the provided adapter cable. The output leads utilize a 2-pin JST-GH connector, while the input lea ds on the MCU use a 2-pin header connector, so the adapter cable provides compatibility between these connectors.
Secure the MCU component 104 to the handlebars of the bike using the provided rubber straps or cable ties. The MCU component 104 contains the circuitry to measure the resistance of the FSR-BL and convert it into a force value. The MCU component 104 is designed to be weather-resistant but should be mounted in an area protected from direct exposure to the elements.
Power on the MCU. The MCU component 104 is powered by an internal rechargeable lithium-ion polymer battery, which can provide up to 8 hours of continuous operation per charge. The battery level is displayed on a small OLED screen on the MCU component 104.
Test and calibrate the FSR-BL. Squeeze the brake lever with varying levels of force to ensure the FSR-BL is responding accurately. The MCU component 104 displays the measured force value on the OLED screen. If the values do not increase appropriately with increasing applied force, the FSR-BL may need to be recalibrated. Recalibration is performed by connecting the MCU component 104 to a mobile app (e.g., brake data application 114), which guides you through the recalibration process.
The FSR-BL installation and setup is now complete. The FSR-BL will accurately measure and relay the force applied to the brake lever to the MCU component 104, which logs the data for analysis of braking performance and technique. The data can be accessed through the mobile app for display and sharing.

### EXAMPLES

Example 1 is a brake monitoring system comprising: at least one of: a first force sensing element (FSE) for brake levers adapted to be attached to a brake lever of a bicycle for detecting brake pressure and to generate first force data representative of the detected brake pressure; and a second force sensing element (FSE) for brake pads adapted to be attached to a brake pad of the bicycle for detecting brake pressure and to generate second force data representative of the detected brake pressure; a microcontroller unit (MCU) component to connect to at least one the first FSE and the second FSE and to read least one of the first force data from the first FSE and the second force data from the second FSE, the MCU component configured to log and store at least one of the first force data and the second force data as stored brake pressure data, the stored brake pressure data stored in a non-volatile storage and/or relayed a to a remote system using wireless or wired communication; and a computing device to connect to the component and receive and display the brake pressure data; wherein the FSE for brake levers, the FSE for brake pads, the MCU component, and a computing device operate to monitor and display brake pressure data.

In Example 2, the subject matter of Example 1 includes, wherein the FSE comprises an FSE sensor, a PCB, a connector, and adhesive to adhere the FSE to a brake pad.

In Example 3, the subject matter of Examples 1-2 includes, wherein the MCU component is configured to connect to both the first FSE for brake levers and the second FSE for brake pads to receive and read brake pressure data from both the brake levers and brake pads.

In Example 4, the subject matter of Examples 1-3 includes, wherein the second FSE for brake pads further comprises a covering for protecting against excessive heat.

In Example 5, the subject matter of Examples 1-4 includes, wherein the MCU component is operatively powered by a battery.

In Example 6, the subject matter of Examples 1-5 includes, a mold for encapsulating the first FSE for brake levers.

In Example 7, the subject matter of Examples 1-6 includes, a case for housing the MCU component, the case adapted to be attached to handlebars or a crossbar of the bicycle.

In Example 8, the subject matter of Examples 1-7 includes, wherein the second FSE for brake levers is inserted on top of the brake lever.

In Example 9, the subject matter of Examples 1-8 includes, a disc inserted between the second FSE for brake pads and brake caliper piston.

In Example 10, the subject matter of Examples 1-9 includes, a wire to connect the second FSE for brake pads to the component.

In Example 11, the subject matter of Examples 1-10 includes, wherein the computing device is adapted to provide GPS data tracking and display of basic and enhanced ride metrics.

In Example 12, the subject matter of Examples 1-11 includes, wherein the first FSE is adapted to measure force along a longitudinal axis of the brake lever.

In Example 13, the subject matter of Examples 1-12 includes, wherein the first FSE is adapted to measure force along a lateral axis of the brake lever.

In Example 14, the subject matter of Examples 1-13 includes, a processor configured to analyze the brake pressure data to generate ride metrics including feathering and brake scoring.

In Example 15, the subject matter of Examples 1-14 includes, a temperature sensor for detecting brake pad temperature and providing temperature data to the computing device.

In Example 16, the subject matter of Examples 1-15 includes, a brake light component adapted to receive brake pressure data from the MCU component and illuminate a brake light when the brake pressure exceeds a threshold level.

In Example 17, the subject matter of Examples 1-16 includes, a vibration component adapted to receive brake pressure data from the MCU component and generate vibration feedback when the brake pressure exceeds a threshold level.

In Example 18, the subject matter of Examples 1-17 includes, a plurality of FSEs attached to the brake pads of both front and rear wheels of the bicycle, the plurality of FSEs configured to provide individual brake pressure data for each wheel.

In Example 19, the subject matter of Examples 1-18 includes, a data processing component adapted to receive brake pressure data from the MCU component and analyze the data to generate reports on braking performance across multiple rides.

Example 20 is a brake monitoring system for a bicycle, comprising: at least one force sense resistor (FSR) attached to at least one of a brake lever and brake pad to detect brake pressure and to generate brake data corresponding to the brake pressure; a microcontroller unit (MCU) component connected to the FSR to receive and process the brake data; a wireless component connected to the MCU component to wirelessly transmit the brake data to a computing device; and the computing device to receive, display, and store the brake data.

In Example 21, the subject matter of Example 20 includes, a GPS component connected to the MCU component to receive and transmit GPS data; and the computing device configured to display the brake data in connection with the GPS data for each recorded ride.

In Example 22, the subject matter of Examples 20-21 includes, wherein the FSR is attached to a rear side of a brake pad of a disc brake assembly.

In Example 23, the subject matter of Examples 20-22 includes, wherein the FSR is attached to the brake lever of a brake assembly.

In Example 24, the subject matter of Examples 20-23 includes, wherein the wireless component is powered by a battery.

In Example 25, the subject matter of Examples 20-24 includes, a second FSR attached to at least one of a second brake lever and brake pad to detect brake pressure from a second brake; a second input connector on the MCU component to connect to the second FSR; and the MCU component being configured to receive and process brake data from both the FSR and the second FSR to calculate an amount of pressure applied to each of the brake and the second brakc.

In Example 26, the subject matter of Examples 20-25 includes, a rubber/plastic case to enclose the wireless component; and a rubber band strap or O-ring to secure the case to handlebars or a crossbar of the bicycle.

In Example 27, the subject matter of Examples 20-26 includes, wherein the computing device is further configured to provide ride metrics.

In Example 28, the subject matter of Example 27 includes, wherein the ride metrics include at least on elevation, speed, feathering and a brake score.

In Example 29, the subject matter of Examples 20-28 includes, wherein the computing device provides an interface to allow the brake data to be shared with a third party application.

Example 30 is a brake monitoring system comprising: a force sense resistor (FSR) for brake levers (FSR-BL) adapted to be attached to a brake lever of a bicycle for detecting brake pressure; a microcontroller (MCU) component adapted to connect to the FSR-BL and to read force data from the FSR-BL, the MCU component comprising a custom printed circuit board (PCB) for mounting a Bluetooth system on a chip (SoC) component, a connector, a battery connector, and resistors, the MCU component configured to log and store the brake pressure data into non-volatile storage and/or relay the brake pressure data to a remote system using wireless or wired communication; a force sense resistor (FSR) for brake pads (FSR-BP) adapted to be attached to a brake pad of a bicycle for detecting brake pressure, the FSR-BP comprising a carbon disc, an FSR, a custom PCB, a connector, and double-sided tape for adhering the FSR-BP to the brake pad; and a computing device adapted to connect to the MCU component and receive and display the brake pressure data; wherein the FSR-BL, FSR-BP, MCU component, and the computing device operate together to monitor and display brake pressure data.

In Example 31, the subject matter of Example 30 includes, wherein the MCU component is configured to connect to both the FSR-BL and FSR-BP to receive and read brake pressure data from both the brake levers and brake pads.

In Example 32, the subject matter of Examples 30-31 includes, wherein the FSR-BP further comprises a Kapton covering for protecting against excessive heat.

In Example 33, the subject matter of Examples 30-32 includes, battery.

In Example 34, the subject matter of Examples 30-33 includes, a foam mold for encapsulating the FSR-BL with a foam.

In Example 35, the subject matter of Examples 30-34 includes, a rubber/plastic case for housing the MCU component, the case adapted to be attached to handlebars or crossbar of the bicycle.

In Example 36, the subject matter of Examples 30-35 includes, wherein the FSR-BL is inserted on top of the brake lever.

In Example 37, the subject matter of Examples 30-36 includes, a carbon disc inserted between the FSR-BP and brake caliper piston.

In Example 38, the subject matter of Examples 30-37 includes, a connection wire for connecting the FSR-BP to the MCU component.

In Example 39, the subject matter of Examples 30-38 includes, wherein the computing device is adapted to provide GPS data tracking and display of basic and enhanced ride metrics.

Example 40 is a method for monitoring brake pressure on a bicycle, comprising: receiving brake data from at least one force sense resistor (FSR) attached to at least one of a brake lever and brake pad; processing the brake data using a microcontroller unit (MCU) component; transmitting the processed brake data wirelessly to a computing device; and storing the brake data.

In Example 41, the subject matter of Example 40 includes, receiving GPS data using a GPS component connected to the MCU component integrating the GPS data with the brake data for each recorded ride; and displaying the integrated data on the computing device.

In Example 42, the subject matter of Examples 40-41 includes, detecting brake pressure from a second brake using a second FSR attached to a second brake lever or brake pad; receiving and processing brake data from both the FSR and the second FSR using the MCU component; and calculating an amount of pressure applied to both brakes.

In Example 43, the subject matter of Examples 40-42 includes, enclosing the wireless component in a rubber/plastic case; and securing the case to handlebars or a crossbar of the bicycle using a rubber band strap or O-ring.

In Example 44, the subject matter of Examples 40-43 includes, providing ride metrics using the computing device; and calculating and displaying ride metrics including at least one of elevation, speed, feathering, and a brake score.

In Example 45, the subject matter of Examples 40-44 includes, sharing the brake data with a third-party application using an interface provided by the computing device; and authenticating the transmission using OAuth.

Example 46 is a method of processing brake data in a brake monitoring system, comprising: receiving brake data from at least one force sense resistor (FSR) attached to at least one of a brake lever and brake pad to detect brake pressure; analyzing the brake data to determine an amount of pressure applied to the brake; storing the brake data into non-volatile storage; and transmitting the brake data to a computing device wirelessly or via wired communication.

Example 47 is a method of providing ride metrics in a brake monitoring system, comprising: receiving brake data and GPS data from at least one force sense resistor (FSR) and a GPS module connected to a microcontroller unit (MCU) module component; calculating ride metrics based on the received brake and GPS data, wherein the ride metrics include, at least one of elevation, speed, feathering, and a brake score; transmitting the ride metrics to a computing device wirelessly or via wired communication; and displaying the ride metrics on the computing device.

Example 48 is a method of sharing brake data with a third-party application in a brake monitoring system, comprising: receiving a request from a third-party application to access brake data from the brake monitoring system; authenticating the request using OAuth; transmitting the brake data to the third-party application using the third-party application's API; receiving a response from the third-party application indicating that the brake data has been successfully received and stored; and displaying a confirmation message on the brake monitoring system indicating that the brake data has been shared with the third-party application.

Example 49 is a non-transitory computer-readable storage medium, the computer-readable storage medium including instructions that when executed by at least one computer, cause the at least one computer to: receive brake data from at least one force sense resistor (FSR) attached to at least one of a brake lever and brake pad; process the brake data using a microcontroller unit (MCU) component; transmit the processed brake data wirelessly to a computing device; and store the brake data.

In Example 50, the subject matter of Example 49 includes, wherein the instructions further configure the at least one computer to: receive GPS data using a GPS component connected to the MCU component integrate the GPS data with the brake data for each recorded ride; and display the integrated data on the computing device.

In Example 51, the subject matter of Examples 49-50 includes, wherein the instructions further configure the at least one computer to: detect brake pressure from a second brake using a second FSR attached to a second brake lever or brake pad; receive and process brake data from both the FSR and the second FSR using the MCU component; and calculate an amount of pressure applied to both brakes.

In Example 52, the subject matter of Examples 49-51 includes, wherein the instructions further configure the at least one computer to: enclose the wireless component in a rubber/plastic case; secure the case to handlebars or a crossbar of the bicycle using a rubber band strap or O-ring.

In Example 53, the subject matter of Examples 49-52 includes, wherein the instructions further configure the at least one computer to: provide ride metrics using the computing device; and calculate and display ride metrics including at least one of elevation, speed, feathering, and a brake score.

In Example 54, the subject matter of Examples 49-53 includes, wherein the instructions further configure the at least one computer to: share the brake data with a third-party application using an interface provided by the computing device; and authenticate the transmission using OAuth.

Example 55 is a non-transitory computer-readable storage medium, the computer-readable storage medium including instructions that when executed by at least one computer, cause the at least one computer to: receive brake data from at least one force sense resistor (FSR) attached to at least one of a brake lever and brake pad to detect brake pressure; analyze the brake data to determine an amount of pressure applied to the brake; store the brake data into non-volatile storage; and transmit the brake data to a computing device wirelessly or via wired communication.

Example 56 is a non-transitory computer-readable storage medium, the computer-readable storage medium including instructions that when executed by at least one computer, cause the at least one computer to: receive brake data and GPS data from at least one force sense resistor (FSR) and a GPS module connected to a microcontroller unit (MCU) module component; calculate ride metrics based on the received brake and GPS data, wherein the ride metrics include, at least one of elevation, speed, feathering, and a brake score; transmit the ride metrics to a computing device wirelessly or via wired communication; and display the ride metrics on the computing device.

Example 57 is a non-transitory computer-readable storage medium, the computer-readable storage medium including instructions that when executed by at least one computer, cause the at least one computer to: receive a request from a third-party application to access brake data from the brake monitoring system; authenticate the request using OAuth; transmit the brake data to the third-party application using the third-party application's API; receive a response from the third-party application indicating that the brake data has been successfully received and stored; and display a confirmation message on the brake monitoring system indicating that the brake data has been shared with the third-party application.

Example 58 is a computing apparatus comprising: at least one processor; and a memory storing instructions that, when executed by the at least one processor, configure the apparatus to: receive brake data from at least one force sense resistor (FSR) attached to at least one of a brake lever and brake pad; process the brake data using a microcontroller unit (MCU) component; transmit the processed brake data wirelessly to a computing device; and store the brake data.

In Example 59, the subject matter of Example 58 includes, wherein the instructions further configure the apparatus to: receive GPS data using a GPS component connected to the MCU component integrate the GPS data with the brake data for each recorded ride; and display the integrated data on the computing device.

In Example 60, the subject matter of Examples 58-59 includes, wherein the instructions further configure the apparatus to: detect brake pressure from a second brake using a second FSR attached to a second brake lever or brake pad; receive and process brake data from both the FSR and the second FSR using the MCU component; and calculate an amount of pressure applied to both brakes.

In Example 61, the subject matter of Examples 58-60 includes, wherein the instructions further configure the apparatus to: enclose the wireless component in a rubber/plastic case; secure the case to handlebars or a crossbar of the bicycle using a rubber band strap or O-ring.

In Example 62, the subject matter of Examples 58-61 includes, wherein the instructions further configure the apparatus to: provide ride metrics using the computing device; and calculate and display ride metrics including at least one of elevation, speed, feathering, and a brake score.

In Example 63, the subject matter of Examples 58-62 includes, wherein the instructions further configure the apparatus to: share the brake data with a third-party application using an interface provided by the computing device; and authenticate the transmission using OAuth.

Example 64 is a computing apparatus comprising: at least one processor; and a memory storing instructions that, when executed by the at least one processor, configure the apparatus to: receive brake data from at least one force sense resistor (FSR) attached to at least one of a brake lever and brake pad to detect brake pressure; analyze the brake data to determine an amount of pressure applied to the brake; store the brake data into non-volatile storage; and transmit the brake data to a computing device wirelessly or via wired communication.

Example 65 is a computing apparatus comprising: at least one processor; and a memory storing instructions that, when executed by the at least one processor, configure the apparatus to: receive brake data and GPS data from at least one force sense resistor (FSR) and a GPS module connected to a microcontroller unit (MCU) module component; calculate ride metrics based on the received brake and GPS data, wherein the ride metrics include, at least one of elevation, speed, feathering, and a brake score; transmit the ride metrics to a computing device wirelessly or via wired communication; and display the ride metrics on the computing device.

Example 66 is a computing apparatus comprising: at least one processor; and a memory storing instructions that, when executed by the at least one processor, configure the apparatus to: receive a request from a third-party application to access brake data from the brake monitoring system; authenticate the request using OAuth; transmit the brake data to the third-party application using the third-party application's API; receive a response from the third-party application indicating that the brake data has been successfully received and stored; and display a confirmation message on the brake monitoring system indicating that the brake data has been shared with the third-party application.

Example 67 is at least one machine-readable medium including instructions that, when executed by processing circuitry, cause the processing circuitry to perform operations to implement of any of Examples 1-66.

Example 68 is an apparatus comprising means to implement any of Examples 1-66.

Example 69 is a system to implement any of Examples 1-66.

Example 70 is a method to implement any of Examples 1-66.

What is claimed is:

1. A brake monitoring system comprising:
at least one of:
a first force sensing element (FSE) for brake levers adapted to be attached to a brake lever of a bicycle for detecting brake pressure and to generate first force data representative of the detected brake pressure; and
a second force sensing element (FSE) for brake pads adapted to be attached to a brake pad of the bicycle for detecting brake pressure and to generate second force data representative of the detected brake pressure;
a microcontroller unit (MCU) component to connect to at least one of the first FSE and the second FSE and to read at least one of the first force data from the first FSE and the second force data from the second FSE, the MCU component configured to store at least one of the first force data and the second force data as stored brake pressure data; and
a computing device to connect to the component and receive and display the brake pressure data.

2. The brake monitoring system of claim 1, wherein the second FSE comprises an FSE sensor, a PCB, a connector, and adhesive to adhere the second FSE to the brake pad.

3. The brake monitoring system of claim 1, wherein the MCU component is configured to connect to both the first FSE for brake levers and the second FSE for brake pads to receive and read brake pressure data from both the brake levers and brake pads.

4. The brake monitoring system of claim 1, wherein the second FSE for brake pads further comprises a covering to protect against heat.

5. The brake monitoring system of claim 1, wherein the second FSE for brake pads further comprises a disc inserted between the second FSE for brake pads and brake caliper piston.

6. The brake monitoring system of claim 1, further comprising a mold for encapsulating the first FSE for brake levers.

7. The brake monitoring system of claim 1, further comprising a case for housing the MCU component, the case adapted to be attached to handlebars or a crossbar of the bicycle.

8. The brake monitoring system of claim 1, wherein the second FSE for the brake lever is inserted on top of the brake lever.

9. The brake monitoring system of claim 1, wherein the computing device is adapted to provide GPS data tracking and display of ride metrics.

10. The brake monitoring system according to claim 1, further comprising a processor configured to analyze the brake pressure data to generate ride metrics including feathering and brake scoring.

11. The brake monitoring system according to claim 1, further comprising a plurality of brake FSEs attached to the brake pads of both front and rear wheels of the bicycle, the plurality of brake FSEs configured to provide individual brake pressure data for each wheel.

12. A brake monitoring system for a bicycle, comprising:
at least one force sense resistor (FSR) attached to at least one of a brake lever and brake pad to detect brake pressure and to generate brake data corresponding to the brake pressure;
a microcontroller unit (MCU) component connected to the FSR to receive and process the brake data;
a wireless component connected to the MCU component to wirelessly transmit the brake data to a computing device; and
the computing device to receive, display, and store the brake data.

13. The brake monitoring system of claim 12, further comprising:
a GPS component connected to the MCU component to receive and transmit GPS data; and
the computing device configured to display the brake data in connection with the GPS data for each recorded ride.

14. The brake monitoring system of claim 12, wherein the at least one FSR is attached to a rear side of a brake pad of a disc brake assembly.

15. The brake monitoring system of claim 12, wherein the at least one FSR is attached to the brake lever of a brake assembly.

16. The brake monitoring system of claim 12, wherein the computing device provides an interface to allow the brake data to be shared with a third party application.

17. A method for monitoring brake pressure on a bicycle, comprising:
receiving brake data from at least one force sense resistor (FSR) attached to at least one of a brake lever and brake pad;
processing the brake data using a microcontroller unit (MCU) component;
transmitting the processed brake data wirelessly to a computing device; and
storing the brake data.

18. The method of claim 17, further comprising:
receiving GPS data using a GPS component connected to the MCU component integrating the GPS data with the brake data for each recorded ride; and
displaying the integrated data on the computing device.

19. A brake monitoring system comprising:
at least one force sensing element for detecting brake pressure applied between a brake pad and caliper piston of a bicycle;
a processing unit connected to the at least one force sensing element, the processing unit configured to receive and process brake data from the at least one force sensing element;
a data storage unit connected to the processing unit, the data storage unit configured to store the brake data; and
an interface for accessing the brake data.
